(19) United States
(12) Patent Application Publication
(10) Pub. No.: US 2008/0199667 A1
(43) Pub. Date: Aug. 21, 2008

(54) MAGNETIC FIELD CONTROLLED ACTIVE REFLECTOR AND MAGNETIC DISPLAY PANEL COMPRISING THE ACTIVE REFLECTOR

(75) Inventor: Sung Nae CHO, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/028,140

(22) Filed: Feb. 8, 2008

(30) Foreign Application Priority Data
Feb. 16, 2007 (KR) 10-2007-0016783
May 11, 2007 (KR) 10-2007-0046199
Aug. 10, 2007 (KR) 10-2007-0080601

(51) Int. Cl. B32B 7/02; G09G 3/34

(52) U.S. Cl. 428/212; 345/86

(57) ABSTRACT

Provided is an active reflector that transmits or reflects light by being controlled by a magnetic field and a magnetic display panel that employs the active reflector. The active reflector includes a magnetic material layer in which magnetic particles are buried in a transparent insulating medium, and the magnetic material layer has an optical incident surface having an array of hybrid curved surfaces which include a central surface having a convex parabolic shape and an axis of symmetry and a peripheral surface having a focal point on the axis of symmetry of the central surface and a concave parabolic shape extending from the central surface.

### CROSS-REFERENCE TO RELATED PATENT APPLICATION

This application claims the benefit of Korean Patent Application No. 10-2007-0016783, filed on Feb. 16, 2007, No. 10-2007-0046199, filed on May 11, 2007, and No. 10-2007-0080601, filed on Aug. 10, 2007, in the Korean Intellectual Property Office, the disclosures of which is incorporated herein in their entireties by reference.

### BACKGROUND OF THE INVENTION

1. Field of the Invention

Apparatuses consistent with the present invention relate to an active reflector and a magnetic display panel comprising the active reflector, and more particularly, to a magnetic field controlled active reflector that controls transmission or reflection of light according to the application of a magnetic field and a magnetic display panel comprising the active reflector.

2. Description of the Related Art

Currently, liquid crystal display (LCD) panels and plasma display panels (PDPs) are mainly used as flat display panels. Also, organic light emitting diodes (OLEDs) are being studied as next generation flat display panels.

In the case of an LCD panel, an optical shutter that transmits/blocks light emitted from a backlight unit or external light must be included in the LCD panel since the LCD panel is a non-emissive type panel. The optical shutter used in the LCD panel comprises two polarizing plates and a liquid crystal layer disposed between the two polarizing plates. However, if the polarizing plates are absorptive polarizing plates, light-using efficiency is greatly reduced. Thus, studies to use reflective polarizing plates instead of using the absorptive polarizing plates have been conducted. However, in the case of the reflective polarizing plates, manufacturing cost is high and the realization of a large size display panel is difficult to achieve.

Plasma display panels do not require an optical shutter since the plasma display panels are emissive type panels. However, plasma display panels have large power consumption and generate a lot of heat. Also, OLEDs are emissive type panels, and thus, do not require an optical shutter. However, OLEDs are in a developing stage, and thus, have high manufacturing costs and insufficient life span.

In the case of a dual-sided LCD, which is currently under development, in order to increase outdoor visibility, a reflection structure that can use external light is employed in a pixel. However, the reflection structure still does not transmit or reflect light as necessary. Therefore, both sides of a dual-sided display apparatus may have different brightness from each other according to the location of an external light source.

### SUMMARY OF THE INVENTION

To address the above and/or other problems, the present invention provides an active reflector that can control transmission or reflection of light according to the application of a magnetic field.

The present invention also provides a magnetic display panel that employs the magnetic field controlled active reflector.

The present invention also provides a dual-sided display panel that employs the magnetic field controlled active reflector.

According to an aspect of the present invention, there is provided a magnetic field controlled active reflector having a magnetic material layer in which magnetic particles are buried in a transparent insulating medium, wherein the magnetic material layer has an optical incident surface having an array of hybrid curved surfaces which comprise a central surface having a convex parabolic shape and an axis of symmetry in the center of the central surface and a peripheral surface having a focal point on the axis of symmetry of the central surface and a concave parabolic shape extending from the central surface.

The magnetic material layer may reflect all light when a magnetic field is not applied to the magnetic material layer, and when a magnetic field is applied to the magnetic material layer, the magnetic material layer may transmit light having a first polarizing direction and may reflect light having a second polarizing direction which is perpendicular to the first polarizing direction.

The magnetic material layer may have a thickness greater than the magnetic decay length of the magnetic material layer.

The magnetic material layer may be formed such that magnetic particles with a core-shell structure and color absorption particles with a core-shell structure are mixed and distributed in a medium.

Each of the magnetic particles may comprise a magnetic core formed of a magnetic material and an insulating shell that surrounds the magnetic core.

The insulating shell may be formed of a transparent insulating material to surround the magnetic core.

The insulating shell may be formed of a polymer shape surfactant to surround the magnetic core.

One magnetic core may form a single magnetic domain.

The magnetic core may be formed of a magnetic material selected from the group consisting of Co, Fe, Iron oxide, Ni, Co—Pt alloy, Fe—Pt alloy, Ti, Al, Ba, Pt, Na, Sr, Mg, dysprosium (Dy), Mn, gadolinium (Gd), Ag, Cu, and Cr, or an alloy of these materials. In an exemplary embodiment, the cores are formed of any one of (FeᵥPt_{z}), MnZn(Fe₂O₄)₂, Mn Fe₂O₄, Fe₃O₄, Fe₂O₃ and Sr₈CaRe₃Cu₄O₂₄, CoₓZr_{y}Nb_{z}, NiₓFe_{y}Nb_{z}, CoₓZr_{y}Nb_{z}Feᵥ, wherein x, y, v and z present a composition rate.

If the magnetic decay length of the magnetic core is s and the diameter of the magnetic core is d for a wavelength of incident light, the required number n of magnetic cores along a path of light that travels in the thickness direction of the magnetic material layer may be n≧s/d.

The color absorption particles may have a size smaller or equal to that of the magnetic particles.

Each of the color absorption particles may comprise a core formed of a dielectric and a shell formed of a metal.

The color absorption particles having different core/shell radius ratios from each other may be distributed in the magnetic material layer.

The magnetic material layer may be formed on a transparent substrate by curing a coated solution, in which the magnetic particles are immersed together with a dye.

The magnetic field controlled active reflector may further comprise a magnetic field applying element for applying a magnetic field to the magnetic material layer, wherein the magnetic field applying element comprises a plurality of wires disposed parallel to each other around the magnetic material layer and a power source that supplies a current to the wires.

The wires may be disposed to surround the magnetic material layer.

The wires may be disposed on either an upper surface or a lower surface of the magnetic material layer.

The wires may be formed of one material selected from the group consisting of indium tin oxide (ITO), Al, Cu, Ag, Pt, Au, and iodine-doped polyacetylene.

The magnetic field controlled active reflector may further comprise a magnetic field applying element for applying a magnetic field to the magnetic material layer, wherein the magnetic field applying element comprises a plate shape transparent electrode disposed on a surface of the magnetic material layer and a power source that supplies a current to the board shape transparent electrode.

The plate shape transparent electrode may be formed of ITO or a conductive metal having a thickness thinner than a skin depth of the conductive metal.

According to an aspect of the present invention, there is provided a magnetic display pixel comprising: a magnetic material layer that transmits light when a magnetic field is applied and does not transmit light when a magnetic field is not applied; a reflector disposed on a lower surface of the magnetic material layer to reflect light that has passed through the magnetic material layer; a first electrode disposed on a lower surface of the reflector; a second electrode disposed on an upper surface of the magnetic material layer; and a spacer disposed on a surface of the magnetic material layer to electrically connect the first electrode to the second electrode, wherein a dye or color absorption particles are mixed in the magnetic material layer.

The magnetic material layer may transmit light of a first polarizing direction and may reflect light of a second polarizing direction which is perpendicular direction to the first polarizing direction when a magnetic field is applied, and may reflect all light when a magnetic field is not applied to the magnetic material layer.

The magnetic material layer may have a structure in which magnetic particles are buried in a medium without agglomeration.

The magnetic material layer may have a thickness greater than a magnetic decay length of the magnetic material layer.

The magnetic material layer may be formed such that such that magnetic particles and color absorption particles are mixed and distributed in the medium without agglomeration.

Each of the magnetic particles may comprise a magnetic core formed of a magnetic material and an insulating shell that surrounds the magnetic core.

The insulating shell may be formed of a transparent insulating material to surround the magnetic core.

The insulating shell may be formed of a polymer shape surfactant to surround the magnetic core.

One magnetic core may form a single magnetic domain.

The magnetic core may be formed of a magnetic material selected from the group consisting of Co, Fe, Iron oxide, Ni, Co—Pt alloy, Fe—Pt alloy, Ti, Al, Ba, Pt, Na, Sr, Mg, dysprosium (Dy), Mn, gadolinium (Gd), Ag, Cu, and Cr, or an alloy of these materials.

If the magnetic decay length of the magnetic core is s and the diameter of the magnetic core is d for a wavelength of incident light, the required number n of magnetic cores along a path of light that travels in the thickness direction of the magnetic material layer may be n≧s/d.

The color absorption particles may have a size smaller or equal to that of the magnetic particles.

Each of the color absorption particles may comprise a core formed of a dielectric and a shell formed of a metal.

The color absorption particles having different core/shell radius ratios from each other may be distributed in the magnetic material layer.

The magnetic material layer may be formed on a transparent substrate by curing a coated solution, in which the magnetic particles are immersed together with a dye.

The magnetic display pixel may further comprise a transparent front substrate on which the first electrode is disposed and a rear substrate on which the second electrode is disposed.

The magnetic display pixel may further comprise a anti-reflection coating formed on at least one optical surface from the magnetic material layer to an upper surface of the front substrate.

The magnetic display pixel may further comprise an absorptive polarizer formed on the at least one of the optical surfaces from the magnetic material layer to the upper surface of the front substrate.

The reflector may have a reflection surface having an array of hybrid curved surfaces which comprise a central surface having a convex parabolic shape and an axis of symmetry in the center of the central surface and a peripheral surface having a focal point on the axis of symmetry of the central surface and a concave parabolic shape extending from the central surface.

The first electrode, the second electrode, and the conductive spacer may be formed of one selected from the group consisting of Al, Cu, Ag, Pt, Au, and iodine-doped polyacetylene.

The first electrode may comprise a plurality of first holes so that light passes through the first electrode and a plurality of wires formed due to the formation of the first holes and extending in a current proceeding direction between the first holes.

A light transmissive material may be formed in the first holes of the first electrode between the wires.

The second electrode may comprise a second hole in a region facing the magnetic material layer so that light passes through the second electrode.

A light transmissive material may be formed in the second hole of the second electrode.

The second electrode may be wires of a mesh structure or a lattice structure that is electrically connected to the conductive spacer.

The first and second electrodes may be formed of a transparent conductive material.

The magnetic display pixel may further comprise a control circuit that is disposed on a side of the magnetic material layer and between front and rear substrates to switch a current flow between the first electrode and the second electrode.

The magnetic display pixel may further comprise black matrixes disposed on the upper surface of the second electrode on regions facing the control circuit and the conductive spacer.

According to an aspect of the present invention, there is provided a magnetic display panel comprising a plurality of magnetic display pixels described above.

The magnetic display panel may be a flexible display panel in which the front substrate, the rear substrate, the first electrode, and the second electrode are formed of flexible materials.

The front substrate and the rear substrate may be formed of a light transmissive resin, and the first and second electrodes may be formed of a conductive polymer material.

The magnetic display panel may further comprise an organic thin film transistor that is disposed on a side of the magnetic material layer between the front substrate and the rear substrate and switches a current flow between the first electrode and the second electrode.

The magnetic display panel may comprise a flexible display unit on which a plurality of magnetic display pixels are arranged and aseparate control unit that individually switches a current flow between the first electrode and the second electrode with respect to each of the sub-pixels.

A plurality of magnetic display pixels may commonly use the front substrate, the rear substrate, and the second electrode, and each of the magnetic display pixels may comprise the magnetic material layer and the first electrode for applying a magnetic field to the magnetic material layer.

According to another aspect of the present invention, there is provided a dual-sided magnetic display panel having a symmetrical structure in which the first and second magnetic display panels comprising magnetic display pixels described above are disposed to face each other.

The rear substrate may be transparent.

The reflectors of the first and second magnetic display panels may be composite reflectors in which active reflectors and inactive reflectors are alternately disposed, and the active reflector may comprise a magnetic material layer in which magnetic particles are buried in a transparent insulating medium, wherein the active reflector reflects all light when a magnetic field is not applied and, when a magnetic field is applied, the active reflector transmits light having a first polarizing direction and reflects light having a second polarizing direction which is perpendicular to the first polarizing direction.

The dual-sided magnetic display panel may further comprise a backlight unit between the first magnetic display panel and the second magnetic display panel.

According to another aspect of the present invention, there is provided an electronic apparatus that employs the magnetic display panel having the magnetic display pixels described above.

### BRIEF DESCRIPTION OF THE DRAWINGS

The above and other features of the present invention will become more apparent by describing in detail exemplary embodiments thereof with reference to the attached drawings in which:

FIG. 1 is a schematic perspective view of a magnetic field controlled active reflector, according to an exemplary embodiment of the present invention;

FIG. 2 is a cross-sectional view of the magnetic field controlled active reflector of FIG. 1;

FIG. 3 is a schematic drawing of an exemplary structure of a core-shell shaped magnetic particle used in a magnetic material layer of the magnetic field controlled active reflector of FIG. 1, according to an exemplary embodiment of the present invention;

FIG. 4 is a schematic perspective view of a case that the magnetic field controlled active reflector according to an exemplary embodiment of the present invention is in an OFF state when a magnetic field is not applied to the magnetic material layer, according to an exemplary embodiment of the present invention;

FIG. 5 is a schematic perspective view of a case that the magnetic field controlled active reflector according to an exemplary embodiment of the present invention is in an ON state when a magnetic field is applied to the magnetic material layer, according to an exemplary embodiment of the present invention;

FIGS. 6 and 7 are graphs showing the transmission of a magnetic field in a magnetic field controlled active reflector, according to an exemplary embodiment of the present invention;

FIGS. 8A and 8B are schematic drawings showing another exemplary structure of a magnetic material layer of a magnetic field controlled active reflector, according to an exemplary embodiment of the present invention;

FIGS. 9 through 11 are cross-sectional views of surface shapes of a magnetic field controlled active reflector, according to exemplary embodiments of the present invention, and various methods of applying a magnetic field to the magnetic material layer of the magnetic field controlled active reflector;

FIG. 12 is a schematic top view showing an arrangement of the magnetic field controlled active reflector of FIGS. 9 through 11, according to exemplary embodiment of the present invention;

FIG. 13 is a schematic cross-sectional view of the structure of a sub-pixel of a magnetic display panel that uses the magnetic field controlled active reflector, according to an exemplary embodiment of the present invention;

FIG. 14 is a schematic perspective view showing an exemplary structure of a sub-pixel electrode, a conductive spacer, and a common electrode of the sub-pixel of FIG. 13, according to an exemplary embodiment of the present invention;

FIG. 15A is a schematic drawing of a magnetic field distribution formed around wires of the sub-pixel electrode;

FIG. 15B is a cross-sectional view taken along line A-A′ of FIG. 14, showing cross-sectional structures of the sub-pixel electrode, a magnetic material layer, and the common electrode;

FIG. 16 is a schematic perspective view of a sub-pixel arrangement and a structure of the common electrode of a magnetic display panel, according to an exemplary embodiment of the present invention;

FIG. 17 is a schematic perspective view of a sub-pixel arrangement and a structure of the common electrode of a magnetic display panel, according to another exemplary embodiment of the present invention;

FIG. 18 is a schematic perspective view of a sub-pixel arrangement and a structure of the common electrode of a magnetic display panel, according to another exemplary embodiment of the present invention;

FIG. 19 is a schematic perspective view of a sub-pixel arrangement and a structure of the common electrode of a magnetic display panel, according to another exemplary embodiment of the present invention;

FIG. 20 is a schematic cross-sectional view showing operation of a magnetic display panel in which a sub-pixel is in an OFF state, according to an exemplary embodiment of the present invention;

FIG. 21 is a schematic cross-sectional view showing operation of a magnetic display panel in which a sub-pixel is in an ON state, according to an exemplary embodiment of the present invention;

FIG. 22 is a schematic cross-sectional view of a sub-pixel of a dual-sided magnetic display panel, according to an exemplary embodiment of the present invention;

FIG. 23 is a schematic cross-sectional view of a sub-pixel of a dual-sided magnetic display panel, according to another exemplary embodiment of the present invention;

FIG. 24 is a schematic cross-sectional view showing operation of the dual-sided magnetic display panel of FIG. 22 when the sub-pixels on both sides of the dual-sided magnetic display panel are in an ON state;

FIG. 25 is a schematic cross-sectional view showing operation of the dual-sided magnetic display panel of FIG. 23 when one sub-pixel is in an ON state and the other sub-pixel is in an OFF state;

FIG. 26 is a schematic cross-sectional view showing operation of the dual-sided magnetic display panel of FIG. 22 in which a reflector in which an active reflector and an inactive reflector are alternately arranged;

FIG. 27 is a schematic drawing showing a principle of reflection/transmission of the composite reflector of FIG. 26;

FIG. 28 is a schematic cross-sectional view showing operation of the dual-sided magnetic display panel of FIG. 23 in which the sub-pixels on both sides of the dual-sided magnetic display panel are in an ON state;

FIG. 29 a schematic cross-sectional view of a structure of a sub-pixel of a magnetic display panel according to another exemplary embodiment of the present invention; and

FIG. 30 is a conceptual drawing showing a connection structure between a control unit and a display unit.

### DETAILED DESCRIPTION OF THE EXEMPLARY EMBODIMENTS OF THE INVENTION

The present invention will now be described more fully with reference to the accompanying drawings in which exemplary embodiments of the invention are shown.

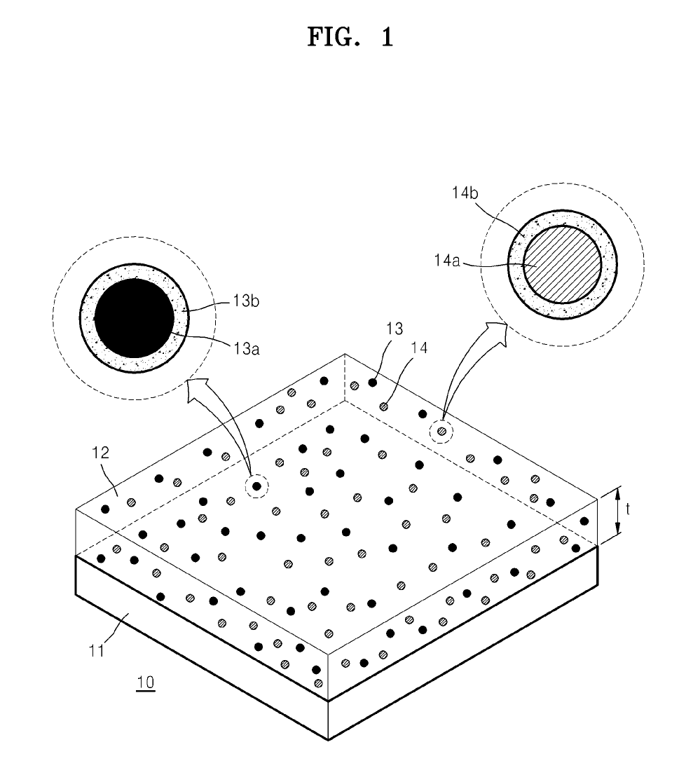

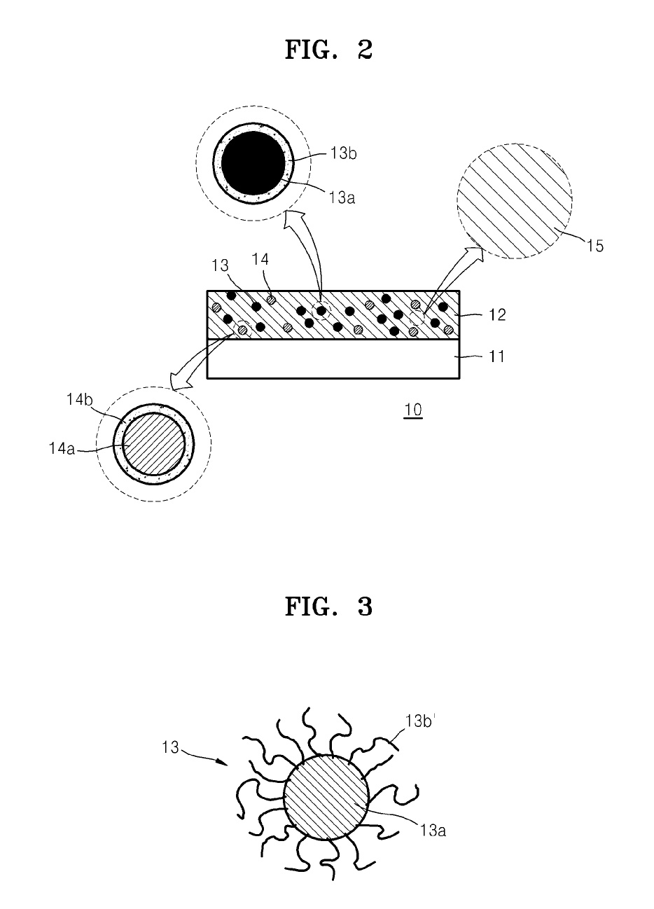

FIG. 1 is a schematic perspective view of a magnetic field controlled active reflector 10 according to an exemplary embodiment of the present invention, and FIG. 2 is a cross-sectional view of the magnetic field controlled active reflector 10 of FIG. 1. Referring to FIGS. 1 and 2, the magnetic field controlled active reflector 10 includes a transparent substrate 11 and a magnetic material layer 12 formed on the transparent substrate 11. The magnetic material layer 12, for example, can have a structure in which a plurality of magnetic particles 13 are buried in a transparent insulating medium 15. In FIGS. 1 and 2, the magnetic particles 13 in the magnetic material layer 12 are depicted as being sparsely distributed for illustrative purposes; however, in an exemplary embodiment of the invention, the magnetic particles 13 are densely filled in the magnetic material layer 12.

The magnetic particles 13, each formed with a magnetic core 13a, may be buried in the transparent insulating medium 15 without agglomerating or electrically contacting one another. As shown in the magnified views in FIGS. 1 and 2, each of the magnetic particles 13 can include the magnetic core 13a and a transparent non-magnetic insulating shell 13b that surrounds the magnetic core 13a so that the magnetic particles 13 cannot be agglomerated or electrically contact one another. Also, regions between the magnetic particles 13 can also be filled with a non-magnetic transparent insulating dielectric material similar to the transparent non-magnetic insulating shell 13b.

The magnetic core 13a of the magnetic particles 13 can be any material that has both conductivity and magnetic characteristic. For example, a ferromagnetic substance such as cobalt, iron, nickel, Co—Pt alloy, or Fe—Pt alloy; a super paramagnetic metal or alloy; a paramagnetic metal such as titanium, aluminum, barium, platinum, sodium, strontium, magnesium, manganese, and gadolinium or alloy; a diamagnetic metal such as copper or alloy; or an anti-ferromagnetic metal such as chrome that is transformed to a paramagnetic substance at a Neel temperature or above. Also, in addition to metal, a material that has conductivity and magnetic characteristic can be used as the magnetic core 13a of the magnetic particles 13, for example, a material such as a dielectric material, semiconductor, or a polymer. A ferrimagnetic substance, for example, an iron oxide such as MnZn(Fe₂O₄)₂, MnFe₂O₄, Fe₃O₄, Fe₂O₃ or Sr₈CaRe₃Cu₄O₂₄, which has low conductivity, however has very high magnetic susceptibility, can also be used as the magnetic core 13a of the magnetic particles 13.

The diameter of the magnetic core 13a of the magnetic particles 13 must be sufficiently small so that a single magnetic core 13a can form a single magnetic domain. Thus, the diameter of the magnetic core 13a of the magnetic particles 13 can vary from a few nm to a few tens of nm according to the material used to form the magnetic core 13a. For example, the diameter of the magnetic core 13a can be 1 to 200 nm, however, the diameter of the magnetic core 13a can vary depending on the material used to form the magnetic core 13a.

As described above, the transparent non-magnetic insulating shell 13b prevents the magnetic particles 13 from being agglomerated or electrically contacting one another. For this purpose, the magnetic core 13a can be surrounded by the transparent non-magnetic insulating shell 13b formed of a non-magnetic transparent insulating dielectric material such as SiO₂ or ZrO₂. Also, as depicted in FIG. 3, the magnetic core 13a can be surrounded by a shell 13b′ formed of a polymer shape surfactant. The polymer shape surfactant of the shell 13b′ may be transparent, and have insulating and non-magnetic characteristics. The transparent non-magnetic insulating shell 13b and the shell 13b′ can have a thickness that can prevent the magnetic cores 13a of the magnetic particles 13 adjacent to each other from being electrically connected to each other.

The magnetic material layer 12 can be formed by curing a solution in which the magnetic particles 13 having core-shell structures are immersed after the solution is spin coated or deep coated to a small thickness on the transparent substrate 11. In addition to the above method, any other methods by which the magnetic particles 13 are present in the magnetic material layer 12 without agglomerating or electrically contacting one another can be used to form the magnetic material layer 12.

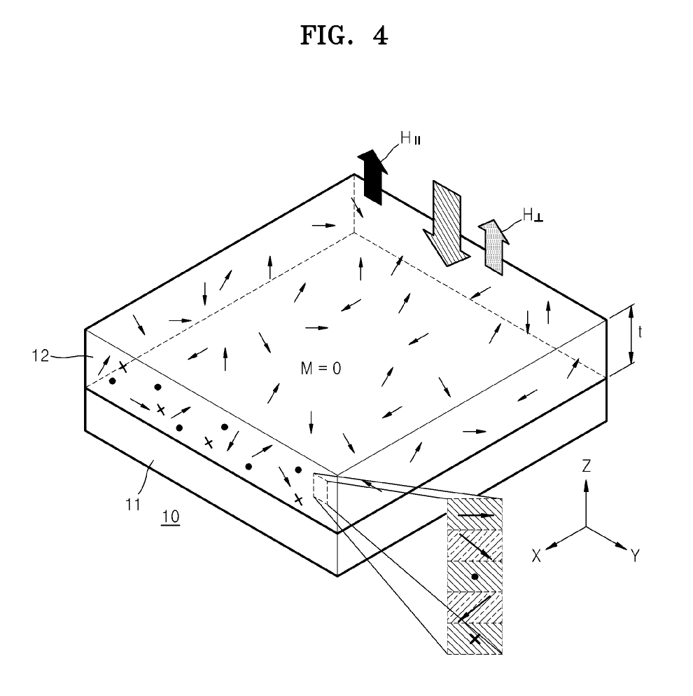

FIG. 4 is a schematic perspective view showing the orientations of magnetic moments in the magnetic material layer 12 when a magnetic field is not applied to the magnetic material layer 12. When a magnetic field is not applied to the magnetic material layer 12, as indicated by the arrows in FIG. 4, the magnetic moments in the magnetic material layer 12 are randomly oriented in various directions. In FIG. 4, ‘’ indicates the magnetic moments in a +x direction on an x-y plane, and ‘x’ indicates the magnetic moments in a [symbol] direction on the x-y plane. Also, as shown in a magnified view of FIG. 4, the magnetic moments in the magnetic material layer 12 are randomly oriented not only in the x-y direction, however also in a vertical direction (−z direction). Accordingly, when a magnetic filed is not applied to the magnetic material layer 12, a total magnetization in the magnetic material layer 12 is 0, that is, M=0.

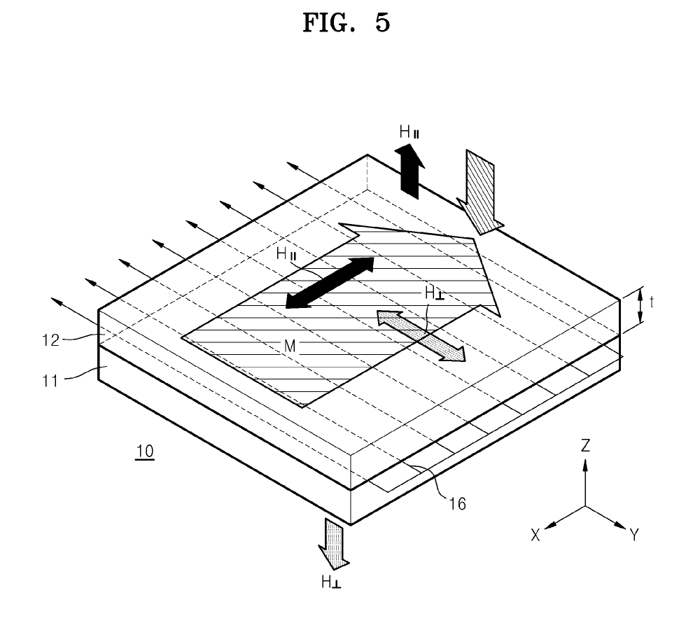

FIG. 5 is a schematic perspective view showing that a magnetic field is applied to the magnetic material layer 12. In order to apply a magnetic field to the magnetic material layer 12, as depicted in FIG. 5, a plurality of wires 16, as a means of applying the magnetic field, can be disposed around the magnetic material layer 12. The wires 16 can be formed of a transparent conductive material, for example, indium tin oxide (ITO). However, in the case that gaps between the wires 16 are much greater than a width of the wires 16, an opaque metal having low resistance, such as Al, Ag, Pt, Au, Cr, Na, Sr, or Mg, can be used instead of ITO. In addition to metal, the wires 16 can be formed of a conductive polymer such as iodine-doped poly-acetylene. In FIG. 5, the wires 16 are disposed on a lower surface of the magnetic material layer 12; however, the present invention is not limited thereto, and thus, the wires 16 can be disposed on an upper surface of the magnetic material layer 12 or formed surrounding the magnetic material layer 12.

Instead of the wires 16, plate shape electrodes formed of a transparent conductive material such as ITO can be formed on the entire surface of the magnetic material layer 12. Recently, a technique for coating a metal to a thickness of a few nm or less has been developed. When a conductive metal is formed to a thickness less than a skin depth of the conductive metal, light can be transmitted. Thus, the plate shape electrodes can be formed instead of the wires 16 by coating a conductive metal on the entire surface of the magnetic material layer 12 to a thickness less than the skin depth of the conductive metal.

If a magnetic field is applied to the magnetic material layer 12 using the magnetic field applying means as described above, all of the magnetic moments in the magnetic material layer 12 are arranged in one direction along the magnetic field. For example, as depicted in FIG. 5, when a current flows along the wires 16 in a −y direction, all of the magnetic moments in the magnetic material layer 12 are arranged in a −x direction. Thus, the magnetic material layer 12 is magnetized in the −x direction.

An operation principle of the magnetic material layer 12 having the above-described structure will now be described.

A magnetic field of an electromagnetic wave that enters the magnetic material layer 12 can be divided into a perpendicular component H_ which is perpendicular to the magnetization direction of the magnetic material layer 12 and a parallel component H_{∥} which is parallel to the magnetization direction of the magnetic material layer 12. If the parallel component H_{∥} enters the magnetic material layer 12, an induced magnetic moment is generated by a mutual reaction between the parallel component H_{∥} and magnetic moments that are oriented in the magnetization direction. The induced magnetic moment which was generated is time-varying according to the time-varying amplitude of the parallel component H_{∥} of the magnetic field. As a result, electromagnetic waves are generated due to the induced magnetic moment that is time-varying according to a general electromagnetic wave radiation principle. The electromagnetic waves generated in this manner can be radiated in all directions. However, the electromagnetic waves that travel into the magnetic material layer 12, that is, a −z direction, are attenuated in the magnetic material layer 12. When the magnetic material layer 12 is formed to have a thickness t greater than a magnetic decay length, which has a similar concept to a skin depth length of an electric field, of the electromagnetic waves generated by the induced magnetic moment, most of the electromagnetic waves that travel into the magnetic material layer 12 are attenuated in the magnetic material layer 12 and electromagnetic waves that travel in a +z direction only remain. Accordingly, the parallel component H of the magnetic field of the electromagnetic waves, that is parallel to the magnetization direction can be considered as being reflected by the magnetic material layer 12.

However, when the perpendicular component H_{⊥}, which is perpendicular to the magnetization direction of the magnetic material layer 12, enters the magnetic material layer 12, the perpendicular component H does not mutually act with the magnetic moments, and thus, an induced magnetic moment is not generated. As a result, the perpendicular component H_{⊥} of the magnetic field of the electromagnetic waves, that is perpendicular to the magnetization direction is transmitted through the magnetic material layer 12 without attenuation.

As a result, of the magnetic field of electromagnetic waves that enter the magnetic material layer 12, the parallel component H_{⊥} which is parallel to the magnetization direction of the magnetic material layer 12 is reflected by the magnetic material layer 12; however, the perpendicular component H_{⊥} which is perpendicular to the magnetization direction of the magnetic material layer 12 is transmitted through the magnetic material layer 12. Thus, optical energy (S_{∥}=E_{∥}×H_{∥}) related to the magnetic field of the parallel component H_{∥} which is parallel to the magnetization direction of the magnetic material layer 12 is reflected by the magnetic material layer 12, and optical energy (S_{⊥}=E_{⊥}×H_{⊥}) related to the magnetic field of the perpendicular component H which is perpendicular to the magnetization direction of the magnetic material layer 12 is transmitted through the magnetic material layer 12.

As depicted in FIG. 4, if a magnetic field is not applied to the magnetic material layer 12, all of the magnetic moments in the magnetic material layer 12 are randomly distributed not only in the x-y plane, however also in a depth direction, that is, a −z direction. Thus, light that enters the magnetic material layer 12 to which a magnetic field is not applied is reflected. However, as depicted in FIG. 5, when a magnetic field is applied to the magnetic material layer 12, all of the magnetic moments in the magnetic material layer 12 are arranged in one direction. Thus, among light that enters the magnetic material layer 12, light of a polarized component related to a magnetic component of the magnetic field that is parallel to the magnetization direction is reflected by the magnetic material layer 12, and light of a polarized component related to a magnetic component of the magnetic field that is perpendicular to the magnetization direction is transmitted through the magnetic material layer 12. In this regards, the magnetic material layer 12 reflects all incident light when a magnetic field is not applied to the magnetic material layer 12, and when a magnetic field is applied to the magnetic material layer 12, the magnetic material layer 12 can perform as an optical shutter that partly transmits incident light or as a magnetic field controlled active reflector. In other words, the magnetic material layer 12 is switchable between partly transmitting incident light or reflecting all of the incident light depending on whether the magnetic field is applied.

In order to sufficiently reflect the incident light, the magnetic material layer 12 must have a sufficient thickness that can attenuate electromagnetic waves that travel into the magnetic material layer 12. That is, as described above, the magnetic material layer 12 must have a thickness greater than a magnetic decay length of the magnetic material layer 12. In particular, if the magnetic particles 13 are formed of magnetic cores distributed in a medium in the magnetic material layer 12, a sufficient number of magnetic cores must be present in the magnetic material layer 12 along a path through which light passes. For example, assuming that the magnetic material layer 12 is made up of layers stacked in a z direction on the x-y plane in which the magnetic cores are uniformly distributed in a single layer, the number n of magnetic cores required along the optical path through which light passes in the −z direction can be expressed by the following equation.

n≧s/d [Equation 1]

where, s is a magnetic decay length of the magnetic cores for a wavelength of incident light, and d is a diameter of the magnetic core. For example, if the magnetic core has a diameter of 7 nm and a magnetic decay length of 35 nm for a wavelength of incident light, at least five magnetic cores are required along the optical path. Accordingly, if the magnetic material layer 12 is formed of a plurality of magnetic cores distributed in a medium, the thickness of the magnetic material layer 12 can be determined so that the number of magnetic cores greater than n can be present in a thickness direction of the magnetic material layer 12 in consideration of the density of the magnetic cores.

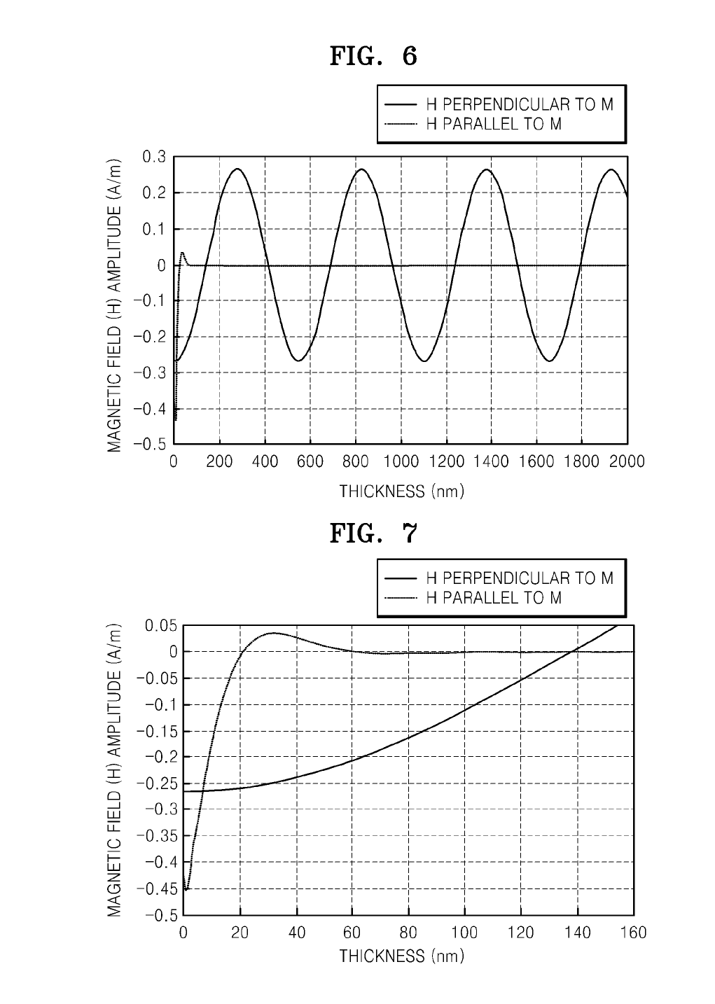

FIGS. 6 and 7 are graphs showing the result of a simulation for assuring the characteristics of the magnetic field controlled active reflector 10, according to an exemplary embodiment of the present invention. FIG. 6 is a graph showing the intensity (A/m) according to the thickness of the magnetic material layer 12, the intensity (A/M) of a time-varying magnetic field that passes through the magnetic field controlled active reflector 10 when a magnetic field is applied to the magnetic field controlled active reflector 10. FIG. 7 is a magnified view of a portion of FIG. 6. The graphs in FIGS. 6 and 7 are calculation results for a case in which titanium was used as a magnetic material for the magnetic material layer 12 and incident light has a wavelength of 550 nm. As it is well known in the art, titanium has a magnetic susceptibility of approximately 18×10⁻⁵ and electrical conductivity of approximately 2.38×10⁶ S (Siemens) at a temperature of 20° C. As depicted in FIGS. 6 and 7, in the case of a magnetic field that is perpendicular to the magnetization direction of the magnetic material layer 12, the magnetic field passes light through the magnetic material layer 12 without a loss even though the thickness of the magnetic material layer 12 increases. However, a magnetic field that is parallel to the magnetization direction of the magnetic material layer 12 is greatly attenuated and at a thickness of approximately 60 nm, the amplitude of the magnetic field converges to almost 0. Thus, if titanium is used as the magnetic material of the magnetic material layer 12 of the magnetic field controlled active reflector 10 according to an exemplary embodiment of the present invention, the magnetic material layer 12 may have a thickness of approximately 60 nm.

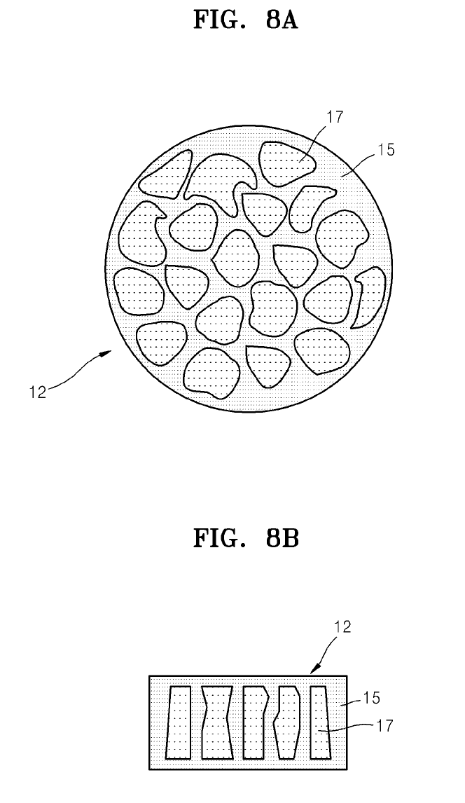

FIGS. 8A and 8B are schematic drawings showing another exemplary structure of the magnetic material layer 12 of the magnetic field controlled active reflector 10, according to an exemplary embodiment of the present invention. FIG. 8A is a horizontal cross-sectional view of the magnetic material layer 12, and FIG. 8B is a vertical cross-sectional of the magnetic material layer 12. The magnetic material layer 12 of FIGS. 8A and 8B has a structure in which magnetic particles 17 having cylindrical shapes instead of a core-shell shape are filled in the transparent insulating dielectric medium 15 such as SiO₂. In this case also, each of the magnetic particles 17 has a size that can form a single magnetic domain, and can be formed of the material of the magnetic particles 13 as described above. The structure of the magnetic material layer 12 can be formed such that, for example, after forming a dielectric template having minute pores using an anodic oxidation, a magnetic material is filled in the dielectric template using a sputtering method.

Also, referring to FIGS. 1 and 2, in the case of the magnetic field controlled active reflector 10, a plurality of color absorbing particles 14 can further be included in the magnetic material layer 12 so that the magnetic material layer 12 can function as a color filter that allows transmitting light to have a specific color. In this case, the magnetic material layer 12 can have a structure in which the magnetic particles 13 and the color absorbing particles 14 are buried in the transparent insulating medium 15.

As in the magnified views in FIGS. 1 and 2, the color absorbing particles 14 can be formed in a core-shell structure in the same manner as the magnetic particles 13. In the case of the magnetic particles 13, each of the magnetic particles 13 is made up of the magnetic core 13a formed of a metal, and the transparent non-magnetic insulating shell 13b formed of a dielectric. However, in the case of the color absorbing particles 14, each of the color absorbing particles 14 is made up of a core 14a formed of a dielectric, and a shell 14b formed of a metal. For example, Au, Ag, or Al is mainly used as the shell 14b of the color absorbing particles 14, and SiO₂ is mainly used as the core 14a of the color absorbing particles 14. The color absorbing particles 14 having such core-shell structure are widely used in a color filter for absorbing a wavelength of a particular band. If light enters a thin metal film formed on a dielectric, a surface plasmon resonance (SPR) is generated at a boundary surface between the dielectric and the thin metal film, and thus, light of a particular wavelength band is absorbed. The resonance wavelength has nothing to do with the size of the core-shell structure and is determined by a diameter ratio between core and shell. However, in order to generate the SPR, the color absorbing particles 14 may each have a diameter of approximately 50 nm or less.

In FIGS. 1 and 2, the color absorbing particles 14 of the same kind are distributed into the magnetic material layer 12; however, the color absorbing particles 14 of various kinds can be distributed by mixing the color absorbing particles 14 of various kinds and distributing the mixed color absorbing particles 14 into the magnetic material layer 12. For example, in order to realize green color, color absorbing particles that absorb light of a red color band and color absorbing particles that absorb light of a blue color band can be mixed and distributed in the magnetic material layer 12. Also, in order to realize red color, color absorbing particles that absorb light of a green color band and color absorbing particles that absorb light of a blue color band can be mixed and distributed in the magnetic material layer 12. Accordingly, the color absorbing particles 14 distributed in the magnetic material layer 12 can have different diameter ratios between cores and shells.

The color absorbing particles 14 do not necessarily have a ball shape, and thus can also have a nanorod shape. Even if the color absorbing particles 14 have a nanorod shape, the color absorbing particles 14 can absorb light of a particular wavelength band due to the SPR. In this case, the resonance wavelength is determined by a nanorod aspect ratio. Thus, the color absorbing particles 14 distributed in the magnetic material layer 12 can be a mixture of nanorod shape color absorbing particles 14 with different nanorod aspect ratios and ball shape color absorbing particles 14 with different diameter ratios between cores and shells.

The magnetic field controlled active reflector 10 having the magnetic material layer 12 in which color absorbing particles 14 are disposed, according to an exemplary embodiment of the present invention, performs as a mirror when a magnetic field is not applied to the magnetic field controlled active reflector 10, and performs as a color filter when a magnetic field is applied to the magnetic field controlled active reflector 10. The size of the core-shell structure of the color absorbing particles 14 may be similar to or smaller than the size of the core-shell of the magnetic particles 13. If the size of the color absorbing particles 14 is excessively greater than that of the magnetic particles 13, the performance of the magnetic field controlled active reflector 10 can be reduced.

As described above, one purpose of distributing the color absorbing particles 14 in the magnetic material layer 12 is so that the magnetic field controlled active reflector 10 can function as a color filter. Thus, if the magnetic field controlled active reflector 10 can function as a color filter without affecting the function of the magnetic particles 13, the magnetic material layer 12 can be realized in different forms. For example, the magnetic material layer 12 can be formed by curing the core-shell magnetic particles 13 after the core-shell magnetic particles 13 are distributed in a liquid phase or a paste state color filter medium. Also, after the core-shell magnetic particles 13 are immersed in a solution together with a dye, for a color filter and the solution is coated thinly on a transparent substrate, the magnetic material layer 12 can be formed by curing the solution.

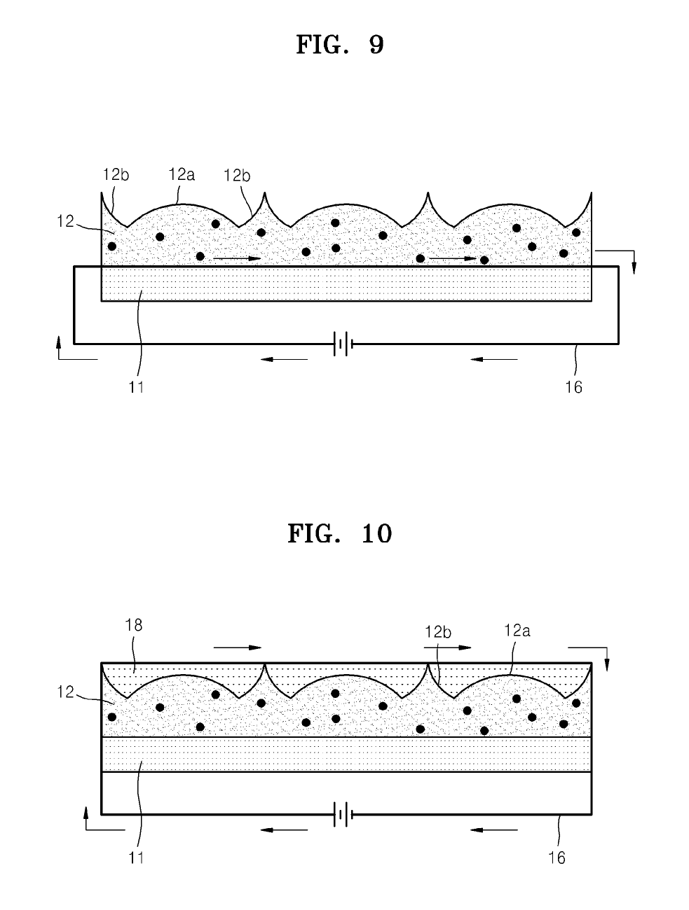

The surface of the magnetic material layer 12 of the magnetic field controlled active reflector 10 according to an exemplary embodiment of the present invention can have a predetermined shape so that the surface of the magnetic material layer 12 can uniformly focus reflected light or transmitted light in a specific region. FIGS. 9 through 11 are cross-sectional views of surface shapes of the magnetic material layer 12 of the magnetic field controlled active reflector 10, according to exemplary embodiments of the present invention, and various methods of applying a magnetic field to the magnetic material layer 12 of the magnetic field controlled active reflector 10.

Referring to FIG. 9, the surface of the magnetic material layer 12 can be formed in an array shape of hybrid surfaces in which two types of curved surfaces are mixed therein. For example, a central surface 12a can have a convex parabolic shape having an axis of symmetry in the center of the central surface 12a. A peripheral surface 12b formed at a periphery of the central surface 12a is a concave surface, has a focal point at about the axis of symmetry of the central surface 12a, and can have a concave parabolic shape extending from the central surface 12a. In this case, most of light reflected or transmitted by the magnetic field controlled active reflector 10 of FIG. 9 travels parallel to the axis of symmetry of the central surface 12a. Thus, the magnetic field controlled active reflector 10 depicted in FIG. 9 can function as a curved surface mirror that allows most of reflected light to travel in a perpendicular direction with respect to a reflection panel, i.e., parallel to the axis of symmetry, in an ON state, and can perform as a semi-transmissive lens that allows most of reflected light and transmitted light to travel in a perpendicular direction with respect to a reflection panel, i.e., parallel to the axis of symmetry, in an OFF state.

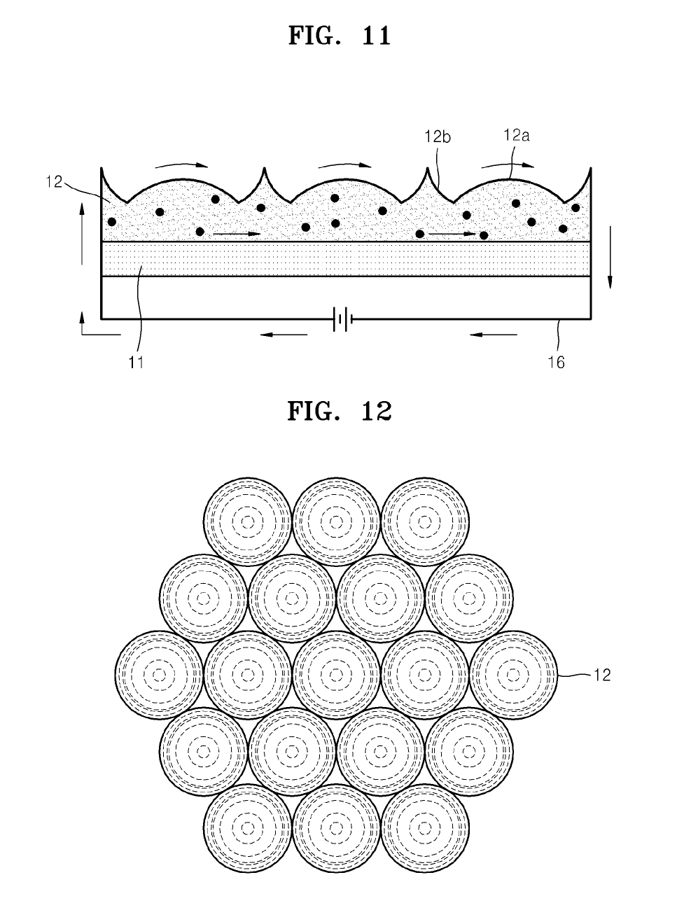

There are various methods of applying the magnetic field to the magnetic material layer 12. For example, in the case of FIG. 9, the wire 16 is disposed at a lower surface of the magnetic material layer 12. However, as shown in FIG. 10, the wire 16 can be disposed on an upper surface of a transparent material layer 18 after the transparent material layer 18 having a flat upper surface is further formed on the magnetic material layer 12. As depicted in FIG. 11, it is also possible that the wire 16 be directly disposed along the surface of the magnetic material layer 12 without the transparent material layer 18.

FIG. 12 is a schematic top view showing an arrangement of the surface of the magnetic material layer 12. As depicted in FIG. 12, the surface of the magnetic material layer 12 may have an array of a plurality of circular elements.

As described above, since the magnetic field controlled active reflector 10 according to an exemplary embodiment of the present invention reflects and blocks all light if a magnetic field is not applied to the magnetic field controlled active reflector 10, and partly transmits light if a magnetic field is applied to the magnetic field controlled active reflector 10, the magnetic field controlled active reflector 10 can be used as an optical shutter. Accordingly, it is possible to manufacture pixels of a display panel using the principle of the magnetic material layer 12 of the magnetic field controlled active reflector 10.

A structure of a magnetic display panel according to an exemplary embodiment of the present invention and operation of the magnetic display panel will now be described in detail.

FIG. 13 is a schematic cross-sectional view of the structure of a sub-pixel 100 of a magnetic display panel, according to an exemplary embodiment of the present invention. Referring to FIG. 13, the sub-pixel 100 of a magnetic display panel includes: a rear substrate 110 and a front substrate 140 that faces the rear substrate 110; a magnetic material layer 130 filled between the rear and front substrates 110 and 140; a sub-pixel electrode 120 partly formed on an inner surface of the rear substrate 110; a common electrode 125 disposed on an inner surface of the front substrate 140; a reflector 131 disposed between the sub-pixel electrode 120 and the magnetic material layer 130; and a conductive spacer 123 that is disposed on a side surface of the magnetic material layer 130 to seal the magnetic material layer 130 and electrically connects the sub-pixel electrode 120 to the common electrode 125.

The rear substrate 110, the front substrate 140, and the common electrode 125 can be used in a common form in the magnetic display panel according to an exemplary embodiment of the present invention. The front substrate 140 must be formed of a transparent material; however, the rear substrate 110 can be not transparent.

According to the present exemplary embodiment, the magnetic material layer 130 has a configuration identical to that of the magnetic material layer 12 of the magnetic field controlled active reflector 10 described above. That is, the magnetic material layer 130 can have a structure in which a plurality of magnetic particles and a plurality of color absorbing particles are buried in a transparent insulating medium. Alternatively, the magnetic material layer 130 can be formed by mixing the magnetic particles having a core-shell structure with a dye for a color filter. However, in the magnetic material layer 130 of the sub-pixel 100 of the magnetic display panel according to the present exemplary embodiment, in order to be used as cores of the magnetic particles, a ferromagnetic material must be in a super paramagnetic state. This is because, in the case of the ferromagnetic material, once the magnetic particles are arranged in a direction, the arrangement state is not readily dispersed. However, in a super paramagnetic region, the ferromagnetic material acts has the same behavior as the paramagnetic material. In order for the ferromagnetic material to be transformed to a super paramagnetic material, the volume of a magnetic core must be less than a single magnetic domain.

Thus, in the magnetic material layer 130 of the sub-pixel 100 of a magnetic display panel according to the present exemplary embodiment, a material for forming the magnetic particles can be, for example, a paramagnetic metal such as Ti, Al, Ba, Pt, Na, Sr, Mg, dysprosium (Dy), Mn, or gadolinium (Gd), or an alloy of these metals; a diamagnetic metal such as Ag or Cu, or an alloy of these metals; and an anti-ferromagnetic metal such as Cr. Also, the magnetic particles can be formed of a superparamagnetic material that is transformed from a ferromagnetic material such as Co, Fe, Ni, Co—Pt alloy, or Fe—Pt alloy; an iron oxide such as MnZn(Fe₂O₄)₂ or MnFe₂O₄, Fe₃O₄, Fe₂O₃; and a ferrimagnetic material such as Sr₈CaRe₃Cu₄O₂₄.

A control circuit 160 for switching a current flow between the sub-pixel electrode 120 and the common electrode 125 can be formed adjacent to the magnetic material layer 130 and between the rear and front substrates 110 and 140. For example, the control circuit 160 can be a thin film transistor (TFT) generally used in a liquid crystal display panel. In the case of using the TFT as the control circuit 160, for example, a current flows between the sub-pixel electrode 120 and the common electrode 125 when the TFT is ON by applying a voltage to a gate electrode of the TFT. Also, a barrier 175 may be formed between the control circuit 160 and the magnetic material layer 130 in order to prevent a material for forming the magnetic material layer 130 from being diffused into the control circuit 160.

A vertical external wall 170 is formed between the common electrode 125 and the rear substrate 110 along edges of the sub-pixel. The vertical external wall 170 completely seals an inner space between the rear and front substrates 110 and 140 from the outside together with the conductive spacer 123.

Also, a black matrix 150 is formed in a region that faces the control circuit 160, the vertical external wall 170, the barrier 175, and the conductive spacer 123 between the front substrate 140 and the common electrode 125. The black matrix 150 covers the control circuit 160, the vertical external wall 170, the barrier 175, and the conductive spacer 123 so that the control circuit 160, the vertical external wall 170, the barrier 175, and the conductive spacer 123 cannot be seen from the outside.

The reflector 131, disposed between the sub-pixel electrode 120 and the magnetic material layer 130, is formed to display an image by reflecting external light that transmits through the magnetic material layer 130. As shown in a magnified view of FIG. 13, the reflector 131 has a predetermined reflection surface so that reflected external light that forms an image by the sub-pixel 100 of the magnetic display panel can travel towards the front face of each sub-pixel 100 of the magnetic display panel. For example, as described above, the surface of the reflector 131 can be formed in an array shape of hybrid surfaces in which two types of curved surfaces are mixed. For example, a central surface of each of the hybrid surfaces of the reflector 131 can have a convex parabolic shape having an axis of symmetry in the center of the central surface. A peripheral surface formed at the periphery of the central surface has a concave surface, has a focal point on the axis of symmetry of the central surface, and can have a concave parabolic shape extending from the central surface.

Although not specifically shown in FIG. 13, in order to prevent dazzling to the eyes due to reflection and dispersion of external light, an anti-reflection coating can be formed at least on any one optical surface from the magnetic material layer 130 to the upper surface of the front substrate 140. For example, an anti-reflection coating can be formed on at least one surface of a surface between the magnetic material layer 130 and the common electrode 125, a surface between the common electrode 125 and the front substrate 140, and the upper surface of the front substrate 140. Instead of the anti-reflection coating, it is also possible to form an absorptive polarizer for absorbing light reflected from the magnetic material layer 130.

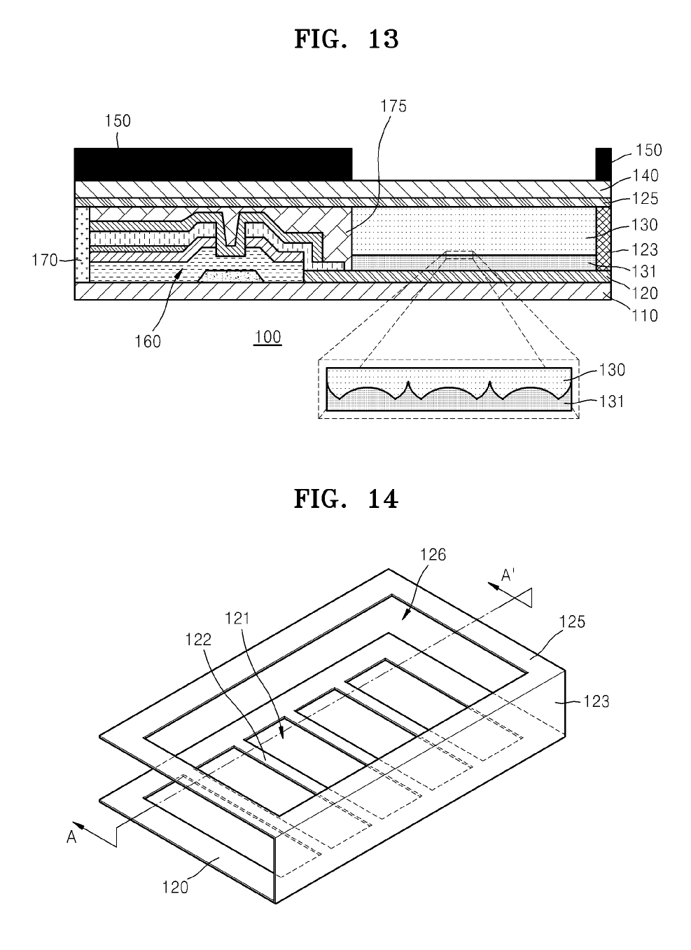

FIG. 14 is a schematic perspective view showing an exemplary structure of the sub-pixel electrode 120, the conductive spacer 123, and the common electrode 125 of the sub-pixel 100 of FIG. 13, according to an exemplary embodiment of the present invention. Referring to FIG. 14, the sub-pixel electrode 120 faces a lower surface of the magnetic material layer 130 depicted in FIG. 13, the common electrode 125 faces the upper surface of the magnetic material layer 130, and the conductive spacer 123 is disposed on the side surface of the magnetic material layer 130 to electrically connect the sub-pixel electrode 120 to the common electrode 125.

The sub-pixel electrode 120, the conductive spacer 123, and the common electrode 125 can be formed of an opaque metal having a low resistance, such as Al, Cu, Ag, Pt, Au, Ba, Cr, Na, Sr, or Mg. Also, in addition to metal, it is also possible to use a conductive polymer such as iodine-doped polyacetylene as a material for forming the sub-pixel electrode 120, the conductive spacer 123, and the common electrode 125.

When an opaque material is used, as depicted in FIG. 14, holes 121 and a hole 126 respectively are formed in the sub-pixel electrode 120 and the common electrode 125 so that light can pass through the sub-pixel electrode 120 and the common electrode 125. At this point, a plurality of relatively small holes 121 parallel to each other are formed in the sub-pixel electrode 120 to have a plurality of wires 122 extending in a current flow direction between the holes 121 so that a magnetic field can be readily applied to the magnetic material layer 130. However, in the common electrode 125, the hole 126 is formed relatively large and having a size corresponding to the magnetic material layer 130.

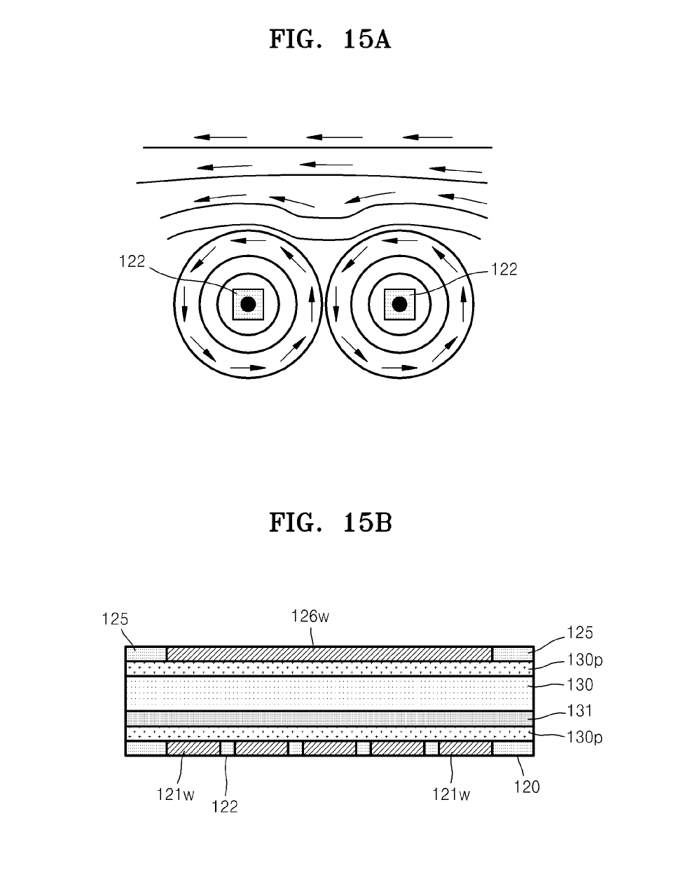

FIG. 15A is a schematic drawing showing a magnetic field formed around the wires 122 of the sub-pixel electrodes 120 when a current is applied to the wires 122 formed as described above. As it can be seen from FIG. 15A, a magnetic field is not formed between the wires 122 since the magnetic fields in opposite directions offset each other, and the magnetic field is more parallel as the magnetic field is further from the wires 122. Thus, in an exemplary embodiment, the magnetic material layer 130 may not to be filled into spaces between the wires 122. Also, in an exemplary embodiment, the magnetic material layer 130 may be disposed a predetermined distance apart from the wires 122.

FIG. 15B is a cross-sectional view taken along line A-A′ of FIG. 14, showing structures of the sub-pixel electrode 120, the magnetic material layer 130, and the common electrode 125. Referring to FIG. 15B, the holes 121 formed between the wires 122 of the sub-pixel electrode 120 and the hole 126 of the common electrode 125 can be respectively filled with light transmissive materials 121w and 126w. Also, an interface between the sub-pixel electrode 120 and the reflector 131 and an interface between the common electrode 125 and the magnetic material layer 130 respectively can be filled with a light transmissive material 130p having a predetermined thickness. Also, it is possible to interpose the light transmissive material 130p between the reflector 131 and the magnetic material layer 130 instead of between the sub-pixel electrode 120 and the reflector 131. In this way, an overall uniform magnetic field can be applied to the magnetic material layer 130, and the penetration of the magnetic material layer 130 into regions of the holes 121 between the wires 122 where the magnetic field is weak or nearly zero can be prevented.

However, in order to manufacture the sub-pixel electrode 120 and the common electrode 125, a conductive material that is transparent to visible light, such as ITO, can be used. In this case, it is unnecessary to form the holes 122 and 126 respectively in the sub-pixel electrode 120 and the common electrode 125. Also, recently, a technique for coating a metal to a few nm or less has been developed. If a conductive metal is formed to a thickness less than a skin depth of the conductive metal, light can be transmitted. Thus, the sub-pixel electrode 120 and the common electrode 125 can be formed by coating a conductive metal to a thickness that is less than the skin depth of the conductive metal.

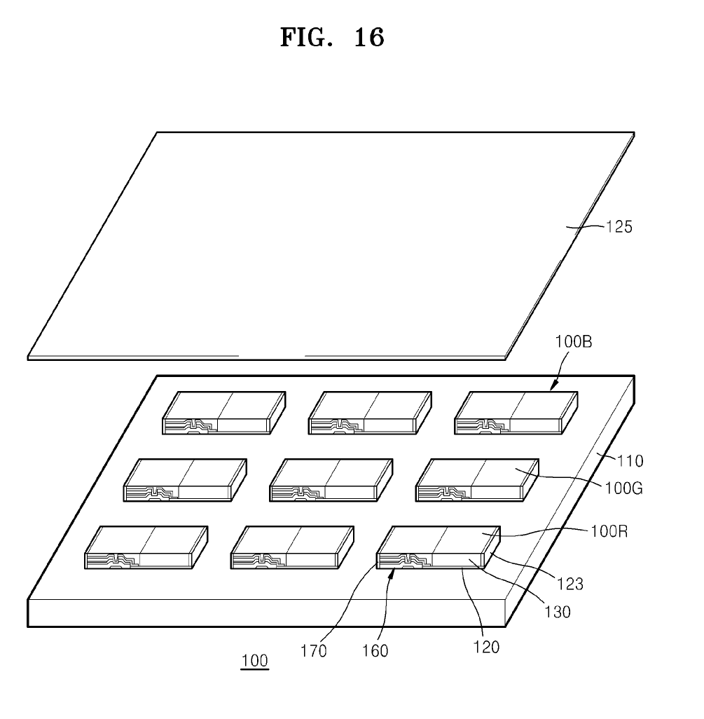

FIGS. 16 through 19 are schematic perspective views of an array of the sub-pixels 100 and various structures of the common electrode 125 in a magnetic display panel 300, according to exemplary embodiments of the present invention.

Referring to FIG. 16, the magnetic display panel 300 can be formed of a two dimensional array of the sub-pixels 100 formed commonly on the rear substrate 110, and the sub-pixels each having a color different from each other can form one pixel. For example, as depicted in FIG. 16, a sub-pixel 100R having red color, a sub-pixel 100G having green color, and a sub-pixel 100B having blue color can constitute one pixel. As described above, the color of each of the sub-pixels 100R, 100G, and 100B can be determined according to color absorption particles or dyes.

Also, the sub-pixels 100R, 100G, and 100B of the magnetic display panel 300 according to the present exemplary embodiment commonly have the common electrode 125. In the case of FIG. 16, the common electrode 125 is a transparent electrode formed of a transparent conductive material such as ITO. In this case, it is unnecessary to form the hole 126 for transmitting light. In such structure, a current flows from the common electrode 125 to the sub-pixel electrode 120 of a corresponding sub-pixel through the conductive spacer 123 only when the control circuit 160 disposed in each of the sub-pixels 100R, 100G, and 100B is ON. In this case, the current flows along a very wide area in the common electrode 125; however, the current flows along a very narrow area in the sub-pixel electrode 120 of each of the sub-pixels 100R, 100G, and 100B, and thus, the sub-pixel electrode 120 has a current density greater than the common electrode 125. Accordingly, the magnetic material layer 130 is affected by the sub-pixel electrode 120 and is almost unaffected by the common electrode 125.

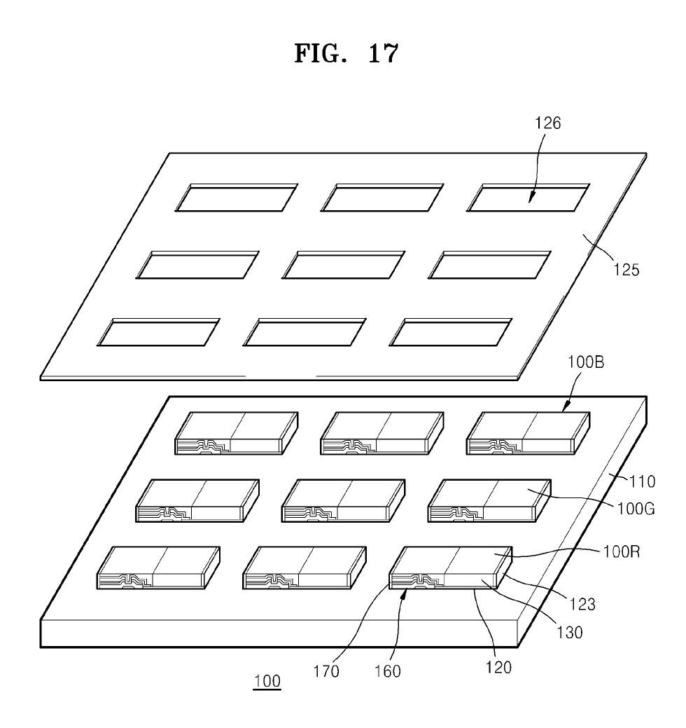

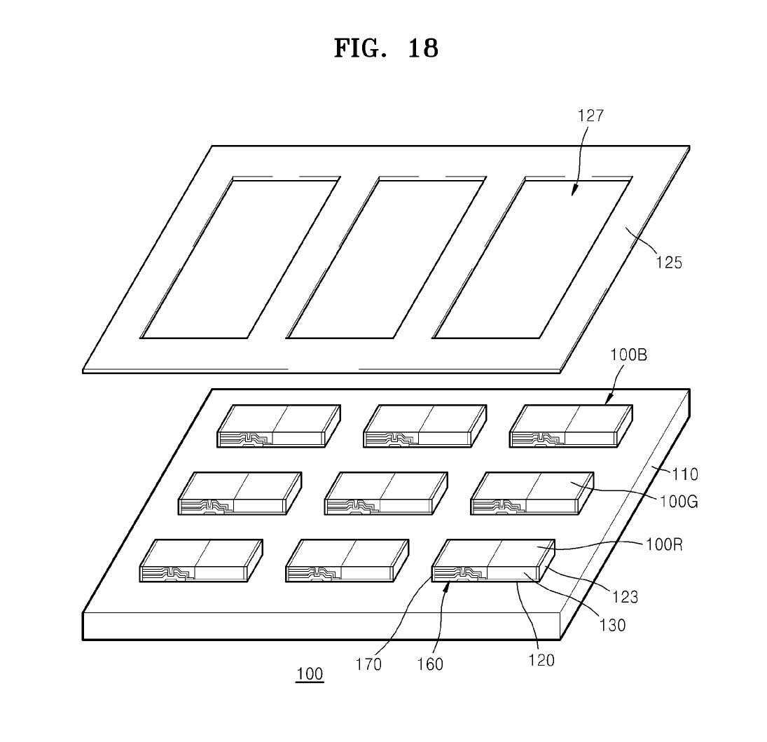

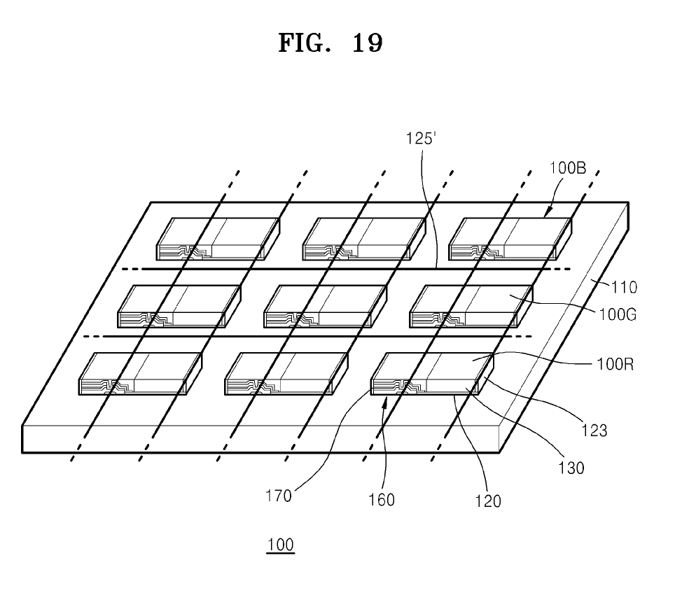

FIGS. 17 and 18 are schematic perspective views of a sub-pixel arrangement in which the common electrode 125 is formed of an opaque metal or a conductive polymer. In FIG. 17, as depicted in FIG. 14, the hole 126, for transmitting light, is formed in the common electrode 125 on locations corresponding to each of the sub-pixels 100R, 100G, and 100B. In the case of FIG. 18, holes 127, for transmitting light, are formed on locations corresponding to one pixel that comprises the three sub-pixels 100R, 100G, and 100B. According to the present exemplary embodiment, the structure of the common electrode 125 is not limited to the shape depicted in FIGS. 16 through 18. In FIGS. 16 through 18, the common electrode 125 is formed of a plate; however, the common electrode 125 can be formed of, for example, wires having a mesh or a lattice structure. FIG. 19 shows a common electrode 125′ having a mesh or a lattice structure. The common electrodes 125 can have any shape as long as the common electrodes 125 can electrically connect to the conductive spacer 123 of each of the sub-pixels 100R, 100G, and 100B. In FIGS. 16 through 18, the common electrode 125 is disposed between the front substrate 140 and the magnetic material layer 130; however, if the common electrode 125 is formed of wires having a mesh or a lattice structure, the common electrode 125 can be disposed in a different position. For example, both the common electrode 125 and the sub-pixel electrode 120 can be formed on the same substrate.

An operation of the sub-pixel 100 of a magnetic display panel according to an exemplary embodiment of the present invention will now be described.

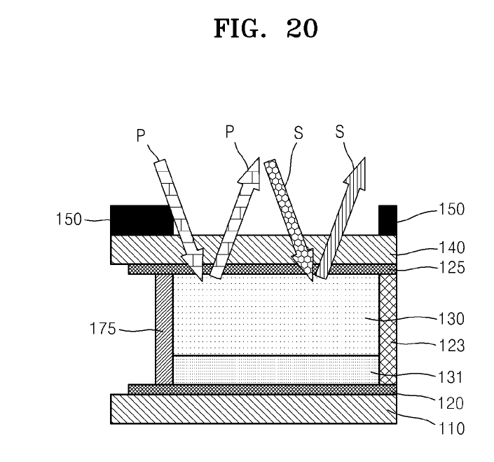

FIG. 20 is a schematic cross-sectional view showing that a current does not flow into the sub-pixel electrode 120 when the control circuit 160 (refer to FIG. 13) is in an OFF state. In this case, since a magnetic field is not applied to the magnetic material layer 130, magnetic moments in the magnetic material layer 130 are oriented in random directions. As described above, all light that enters the magnetic material layer 130 is reflected. As depicted in FIG. 20, the lights S and P that enter the magnetic material layer 130 from external light sources through the front substrate 140 are reflected by the magnetic material layer 130.

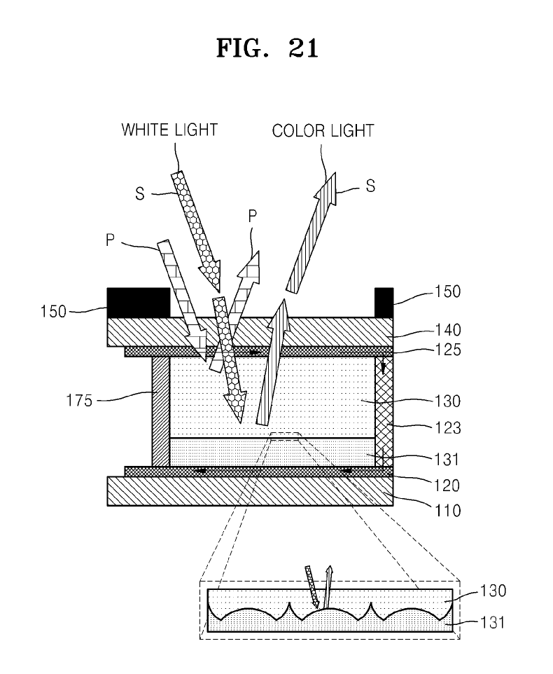

FIG. 21 is a schematic cross-sectional view showing the flow of a current into the sub-pixel electrode 120 when the control circuit 160 (refer to FIG. 13) is in an ON state. In this case, since a magnetic field is applied to the magnetic material layer 130 through the sub-pixel electrode 120, magnetic moments in the magnetic material layer 130 are oriented in one direction. As described above, light of a polarized component (P-polarized component light) related to the component of the magnetic field parallel to the magnetization direction of the magnetic material layer 130 is reflected by the magnetic material layer 130, and light of polarized component (S-polarized component light) related to the component of the magnetic field perpendicular to the magnetization direction of the magnetic material layer 130 is transmitted through the magnetic material layer 130.

For example, as depicted in FIG. 21, of the light that enters the magnetic material layer 130 through the front substrate 140 from an external light source, S-polarized component light S passes the magnetic material layer 130. Afterwards, the S-polarized component light S is reflected by the reflector 131 disposed on the lower surface of the magnetic material layer 130, toward the outside through the magnetic material layer 130 and the front substrate 140. In this process, the light S takes a specific color due to the color absorption particles or a dye in the magnetic material layer 130. Thus, each of the sub-pixels 100R, 100G, and 100B of the magnetic display panel according to the present exemplary embodiment can realize a color image without requiring the use of additional color filters. However, the P-polarized component light P that enters the magnetic material layer 130 through the front substrate 140 is reflected at the surface of the magnetic material layer 130. The reflected light P does not contribute to image formation and the eyes of a viewer can be dazzled by the reflected light P. Thus, as described above, an absorptive polarizer for absorbing the P-polarized component light P can be disposed or an anti-reflection coating can be formed at at least on one optical surface from the magnetic material layer 130 to the front substrate 140.

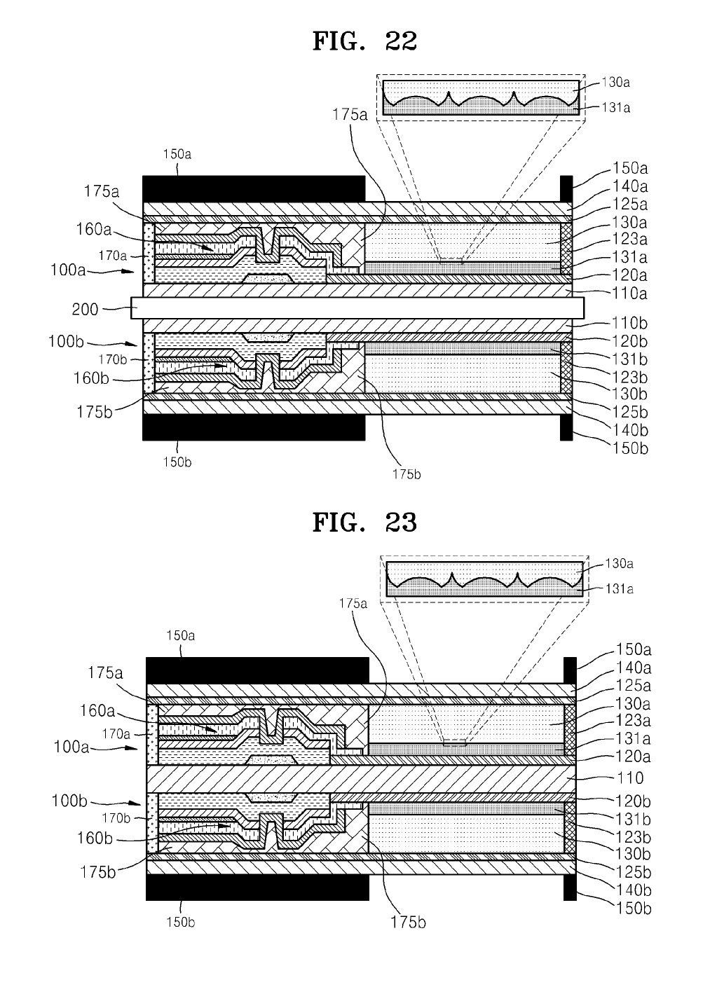

FIGS. 22 and 23 are schematic cross-sectional views of sub-pixels 100a and 110b of a dual-sided magnetic display panel, the sub-pixels 100a and 110b being formed as the sub-pixel 100 of the magnetic display panel of FIG. 13, according to an exemplary embodiment of the present invention. In FIGS. 22 and 23, only the two sub-pixels 100a and 110b are included for convenience of explanation. Referring to FIG. 22, the sub-pixel 100a of a first magnetic display panel and the sub-pixel 100b of a second magnetic display panel are disposed symmetrically on either sides of a backlight unit (BLU) 200 that provides light such that rear substrates 110a and 110b of each of the sub-pixels 100a and 100b face each other. However, in the case of FIG. 23, the sub-pixel 100a of the first magnetic display panel and the sub-pixel 100b of the second magnetic display panel are symmetrically disposed on a common rear substrate 110. The structures of the sub-pixels 100a and 100b of the first and second magnetic display panels are identical to those of the sub-pixel 100 of the magnetic display panel of FIG. 13. That is, the sub-pixels 100a and 100b of the first and second magnetic display panels include: the rear substrates 110a and 110b and front substrates 140a and 140b which are disposed to face each other; magnetic material layers 130a and 130b filled between the rear substrates 110a and 110b and the front substrates 140a and 140b; common electrodes 125a and 125b disposed on inner surfaces of the front substrates 140a and 140b; reflectors 131a and 131b disposed between sub-pixel electrodes 120a and 120b and the magnetic material layers 130a and 130b; and conductive spacers 123a and 123b that are disposed on side surfaces of the magnetic material layers 130a and 130b to seal the magnetic material layers 130a and 130b and electrically connect the sub-pixel electrodes 120a and 120b to the common electrodes 125a and 125b. Also, black matrixes 150a and 150b are formed on regions facing control circuits 160a and 160b, external walls 170a and 170b, tbarriers 175a and 175b, and the conductive spacers 123a and 123b between the front substrates 140a and 140b and the common electrodes 125a and 125b. However, in this case, the rear substrates 110a, 110b and 110 must be formed of a transparent material.

The reflector 131 used in the sub-pixel 100 of the magnetic display panel of FIG. 13 is a conventional inactive reflector not an active reflector; however, the reflectors 131a and 131b of the dual magnetic display panel are active type reflection panels as depicted in FIGS. 9 through 11. In this case, since all of the magnetic material layers 130a and 130b and the reflectors 131a and 131b are applied with a magnetic field by the sub-pixel electrodes 120a and 120b, the magnetic material layers 130a and 130b and the reflectors 131a and 131b are simultaneously turned ON or OFF. Meanwhile, according to the present invention, each of the sub-pixels 100a and 100b of the first and second magnetic display panels can be individually turned ON or OFF.

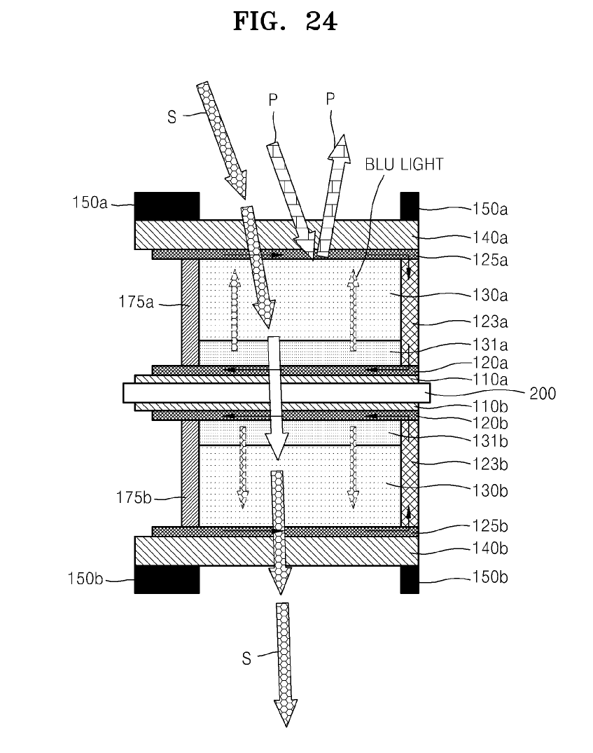

FIG. 24 is a schematic cross-sectional view illustrating an operation of the sub-pixels 100a and 100b of the dual-sided magnetic display panel of FIG. 22 when the sub-pixels 100a and 100b of the first and second magnetic display panels are in an ON state. Here, it is assumed that an external light source such as the sun or an indoor electric light is located at a side of the sub-pixel 100a of the first magnetic display panel.

If both the sub-pixels 100a and 100b of the first and second magnetic display panels are in an ON state, the magnetic material layers 130a and 130b transmit S-polarized component light and reflect P-polarized component light, and the reflectors 131a and 131b act as lenses with respect to the S-polarized component light and act as reflectors with respect to the P-polarized component light. To do these functions, the magnetic material layers 130a and 130b must have a refractive index different from that of the reflectors 131a and 131b. In this case, the magnetic material layers 130a and 130b can be formed of a transparent material different from the reflectors 131a and 131b. Also, in the case that the magnetic material layers 130a and 130b are allowed to perform the color filtering function, the refractive index of the magnetic material layers 130a and 130b can be different from that of the reflectors 131a and 131b.

Of the light emitted from the BLU 200, the S-polarized component light passes through the reflectors 131a and 131b and the magnetic material layers 130a and 130b, and contributes to image formation of the sub-pixels 100a and 100b of the first and second magnetic display panels. The P-polarized component light is repeatedly reflected between the two reflectors 131a and 131b. At this point, if a diffusion plate is provided in the BLU 200, a portion of the P-polarized component light changes into a non-polarized state light, and thus, all light emitted from the BLU 200 can be used for forming an image.

The S-polarized component light of external light S that enters the magnetic material layer 130a through the front substrate 140a of the sub-pixel 100a of the first magnetic display panel passes through the magnetic material layer 130a. Then, the S-polarized component light of the external light S, after being converged by the reflectors 131a and 131b, passes through the sub-pixel 100b of the second magnetic display panel and contributes to the image formation of the sub-pixel 100b of the second magnetic display panel. However, the P-polarized component light of the external light P that enters the magnetic material layer 130a through the front substrate 140a of the sub-pixel 100a of the first magnetic display panel is reflected by the magnetic material layer 130a. The reflected P-polarized component light of the external light P can be absorbed, for example, by an absorptive polarizer.

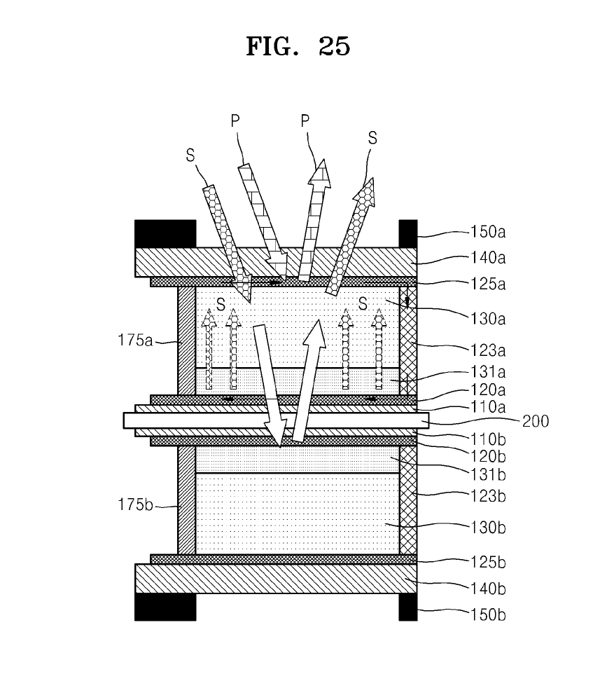

FIG. 25 is a schematic cross-sectional view showing operation of the dual-sided magnetic display panel of FIG. 22 when the sub-pixel 100a in the first magnetic display panel is in an ON state and the sub-pixel 100b in the second magnetic display panel is in an OFF state. Here, it is assumed that an external light source such as the sun or an indoor electric light is located on a side of the sub-pixel 100a of the first magnetic display panel.

In this case, of the light emitted from the BLU 200, a portion of S-polarized component light of the light S passes through the first reflector 131a and the first magnetic material layer 130a and contributes to image formation of the sub-pixel 100a of the first magnetic display panel. The other portion of the S-polarized component light S, after being reflected by the second reflector 131b, passes the first reflector 131a and the first magnetic material layer 130a, and contribute to image formation of the sub-pixel 100a of the first magnetic display panel. The P-polarized component light of the light P is repeatedly reflected between the two reflectors 131a and 131b. At this point, if a diffusion plate is provided in the BLU 200, a portion of the P-polarized component light changes into a non-polarized state light, and thus, all light emitted from the BLU 200 can be used for forming an image by the sub-pixel 100a of the first magnetic display panel.

Also, the S-polarized component light of external light S that enters the first magnetic material layer 130a through the front substrate 140a of the sub-pixel 100a of the first magnetic display panel, after passing through the magnetic material layer 130a and the first reflector 131a, is reflected by the second reflector 131b, and re-passes through the first magnetic material layer 130a. Thus, the S-polarized component light of the external light S contributes to the image formation of the sub-pixel 100a of the first magnetic display panel. However, the P-polarized component light of the external light P that enters the first magnetic material layer 130a through the front substrate 140a of the sub-pixel 100a of the first magnetic display panel is reflected by the first magnetic material layer 130a. As described above, the reflected P-polarized component light of the external light P can be absorbed by, for example, an absorption type polarizing plate.

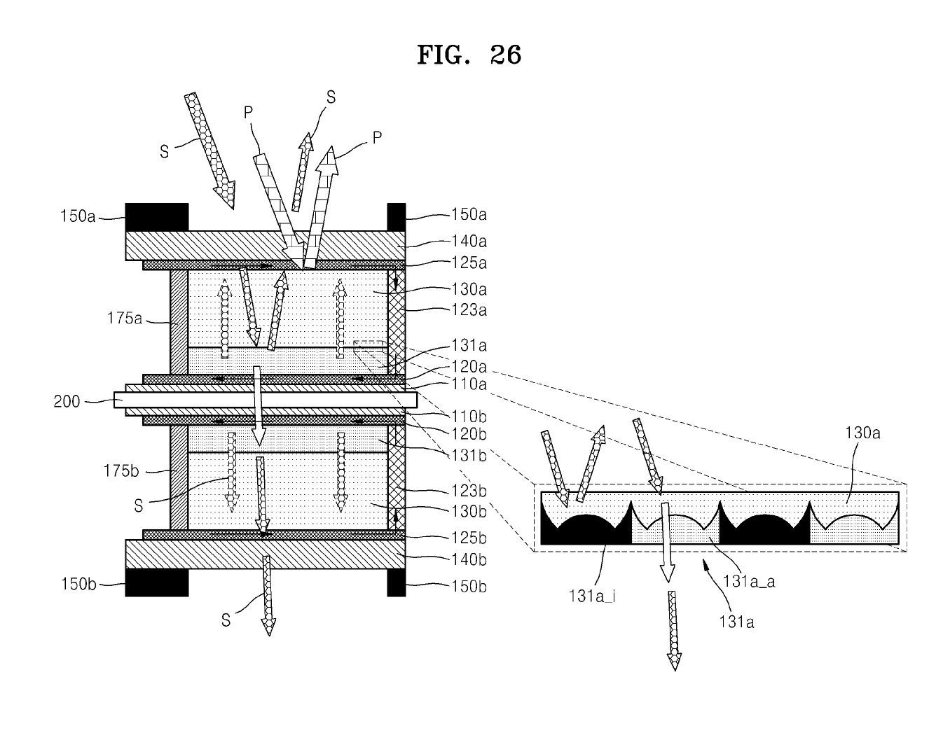

However, as described with reference to FIG. 24, if the sub-pixels 100a and 100b of the first and second magnetic display panels are both in an ON state, and the external light is located only on a side of the double-sided magnetic display panel, the external light contributes to the image formation of the sub-pixel of the double-sided magnetic display panel on an opposite side of the external light. FIG. 26 is a schematic cross-sectional view showing an operation of a dual-sided magnetic display panel in which external light can contribute to image formation of sub-pixels of the first and second magnetic display panels. As depicted in a magnified view on a lower side of FIG. 26, in the present exemplary embodiment, the reflector 131a of the sub-pixel 100a of the first magnetic display panel is a composite reflector in which an active reflector and an inactive reflector are alternately arranged. Although not shown, the reflector 131b of the sub-pixel 100b of the second magnetic display panel is also a composite reflector in which an active reflector and an inactive reflector are alternately arranged.

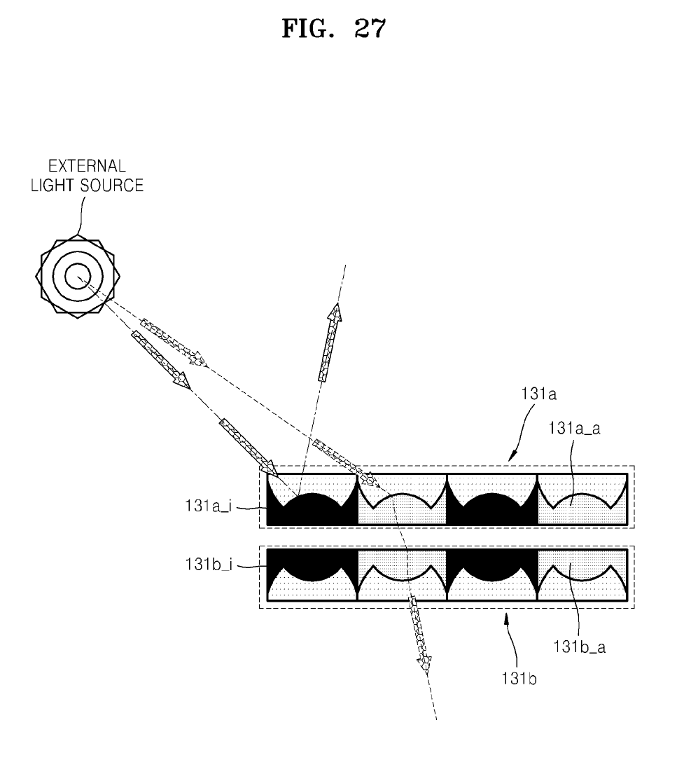

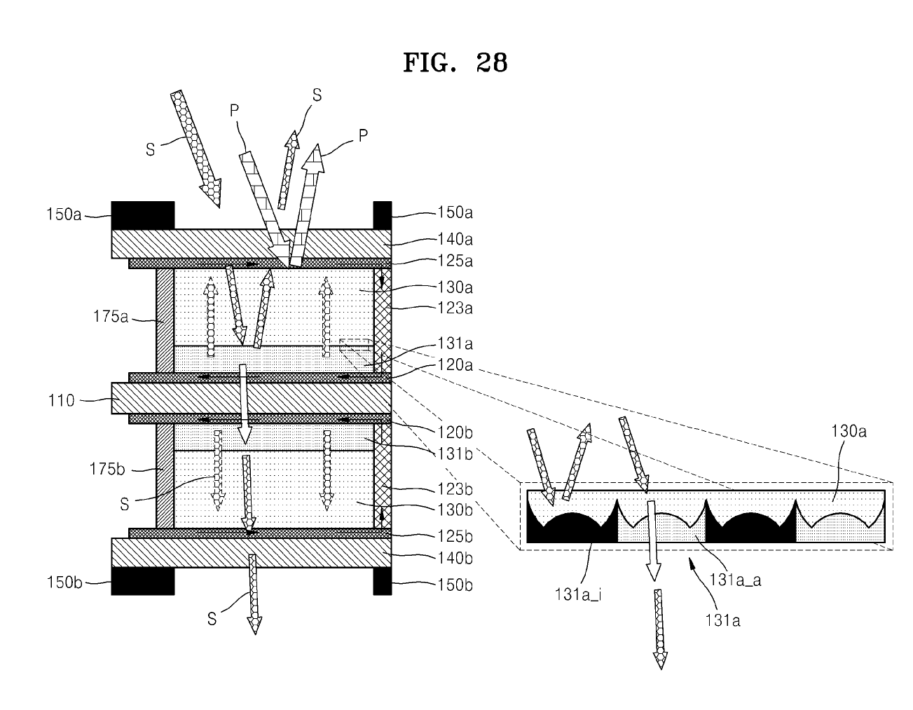

FIG. 27 is a schematic drawing for explaining an operation of the reflectors 131a and 131b with respect to an external light source. Referring to FIG. 27, the two reflectors 131a and 131b are composite reflectors respectively having first and second active reflectors 131a_{—}a and 131b_{—}a and first and second inactive reflectors 131a_{—}i and 131b_{—}i, and the first and second active reflectors 131a_{—}a and 131b_{—}a face each other and also the first and second inactive reflectors 131a_{—}i and 131b_{—}i face each other. If the first and second active reflectors 131a_{—}a and 131b_{—}a are in an ON state, and the external light source is located on a side of the first reflector 131a, a portion of the external light is reflected by the inactive reflector 131a i, and the other portion of the external light passes both through the first and second active reflectors 131a_{—}a and 131b_{—}a. Thus, the external light can be equally distributed to the first reflector 131a and the second reflector 131b.

Referring to FIG. 26 again, when the sub-pixels 100a and 100b of the first and second magnetic display panels are all in an ON state, as described with reference to FIG. 24, light emitted from the BLU 200 contributes to image formation of the sub-pixels 100a and 100b of the first and second magnetic display panels. Also, the S-polarized component light S of external light that enters the magnetic material layer 130a through the front substrate 140a of the sub-pixel 100a of the first magnetic display panel passes through the magnetic material layer 130a. A portion of the S-polarized component light S of the external light that has passed through the magnetic material layer 130a contributes to image formation of the sub-pixel 100a of the first magnetic display panel by being reflected by the inactive reflector 131a_{—}i. The other portion of the S-polarized component light S of the external light that has passed through the magnetic material layer 130a, after being converged by the first and second active reflectors 131a_{—}a and 131b_{—}a, passes through the magnetic material layer 130b of the sub-pixel 100b of the second magnetic display panel, and thus, contribute to image formation of the sub-pixel 100b of the second magnetic display panel.

FIG. 28 is a schematic cross-sectional view showing an operation of the dual-sided magnetic display panel of FIG. 23 in which the sub-pixels 100a and 100b of the first and second magnetic display panels are all in an ON state. Here, it is assumed that an external light source such as the sun or an indoor electric light is located on a side of the first magnetic display panel. The dual-sided magnetic display panel of FIG. 23 uses only the external light without requiring the use of a backlight unit. Thus, in order to equally distribute external light to the sub-pixels 100a and 100b of the first and second magnetic display panels, as described above, the reflectors 131a and 131b may be composite reflectors comprising active reflectors 131a_{—}a and 131b_{—}a and inactive reflectors 131a_{—}i and 131b_{—}i.

Referring to FIG. 28, in this case, S-polarized component light S of the external light that enters the magnetic material layer 130a through the front substrate 140a of the sub-pixel 100a of the first magnetic display panel passes through the magnetic material layer 130a. A portion of the S-polarized component light S of the external light that has passed through the magnetic material layer 130a is reflected by the inactive reflector 131a_{—}i and contributes to image formation of the sub-pixel 100a of the first magnetic display panel. The other portion of the S-polarized component light S of the external light that has passed through the magnetic material layer 130a, after being converged by the active reflectors 131a_{—}a and 131b_{—}a, passes through the magnetic material layer 130b of the sub-pixel 100b of the second magnetic display panel, and thus, can contribute to image formation of the sub-pixel 100b of the second magnetic display panel.

The present invention can be applied to not only inflexible hard flat display panels, but also to easily flexible display panels. In the case of a conventional liquid crystal display panel, a high temperature process is required in the manufacturing processes. Thus, it is difficult to apply flexible substrates that are weak to high temperatures, to flexible displays. However, the magnetic material layer 130 according to the present invention can be manufactured at a high temperature of approximately 130° C., and thus, can be applied to manufacture flexible display panels.

In order to apply the magnetic display panel to a flexible display panel, all constituent elements must be formed of flexible materials. For example, referring to FIG. 13, the rear and front substrates 110 and 140 can be formed of a transparent resin such as polyethylene naphthalate (PEN), polycarbonate (PC), or polyethylene terephthalate (PET). Also, the sub-pixel electrode 120 and the common electrode 125 can be formed of, for example, a conductive polymer material such as iodine-doped polyacetylene. The iodine-doped polyacetylene has a very high conductivity similar to Ag, however is opaque, and thus, is not used in conventional liquid crystal display panels. However, as described above, in the present invention, the sub-pixel electrode 120 and the common electrode 125 are not necessarily transparent. Also, in the control circuit 160, a conventional organic thin film transistor (TFT) that is mainly used in a conventional flexible organic EL display (or flexible OLED display) can be used.

In the case of a backlight unit, in particular, an edge type backlight unit can be configured using a flexible light guide plate formed of a flexible optical transparent material as described above, and a direct type backlight unit can be configured by arranging a light source on a flexible substrate. Also, in the case of applying the magnetic display panel according to the present invention to form a paper like flexible display, a glow material, for example, copper-activated zinc sulfide (ZnS:Cu) or copper and magnesium activated zinc sulfide (ZnS:Cu,Mg) can be used as a light source instead of the backlight unit.

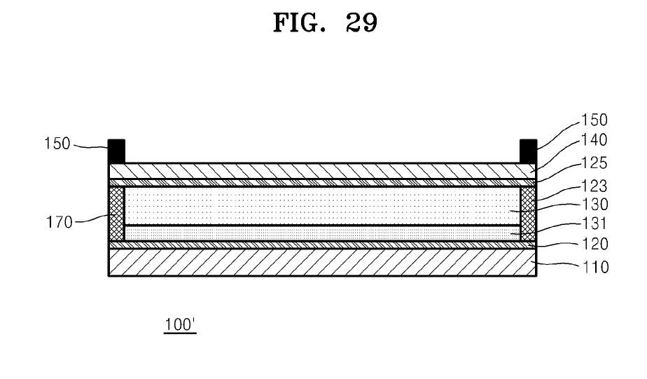

Also, a flexible display can be realized even when using an inorganic TFT instead of an organic TFT. Since the inorganic TFT has a hard structure and requires a high temperature process, the flexible display unit and the control unit respectively are manufactured by separating the transistor part in a sub-pixel structure. FIG. 29 is a schematic cross-sectional view of a structure of a sub-pixel 100′ of a flexible magnetic display panel, according to another exemplary embodiment of the present invention. When the sub-pixel 100′ of the flexible magnetic display panel of FIG. 29 is compared to the sub-pixel 100 of the magnetic display panel of FIG. 13, the difference is that the control circuit 160 in the sub-pixel 100′ was removed. The remaining configuration of the sub-pixel 100′ of the flexible magnetic display panel of FIG. 29 is identical to the configuration of the sub-pixel 100 of the magnetic display panel of FIG. 13. The rear and front substrates 110 and 140, the sub-pixel electrode 120, and the common electrode 125 are formed of the flexible materials as described above.

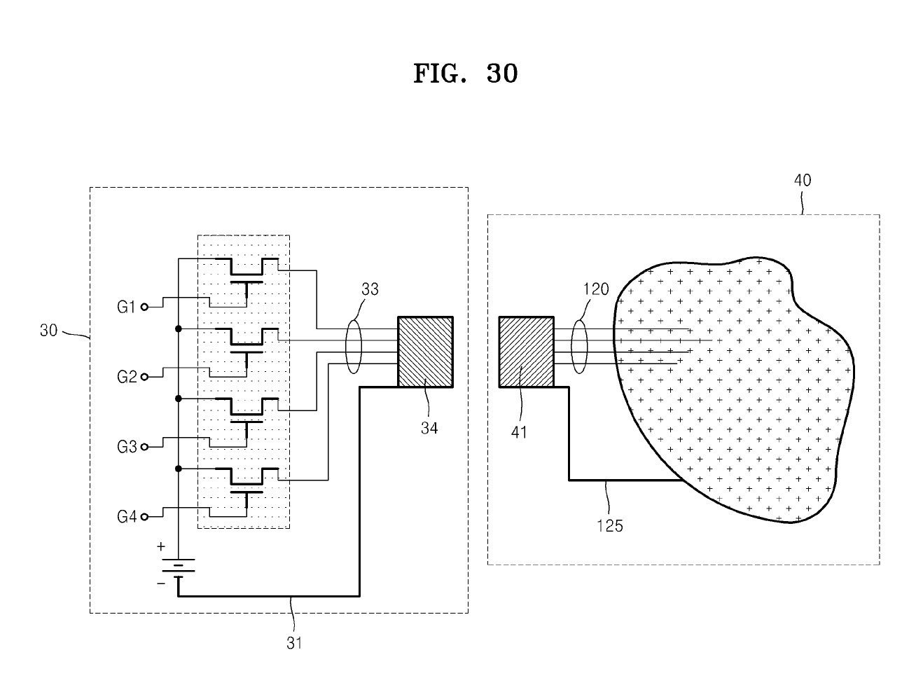

According to the present exemplary embodiment, as depicted in FIG. 30, separately provided are a flexible display unit 40 and a control unit 30, the control unit 30 being formed of inorganic TFTs for driving sub-pixels of the flexible display unit 40 and the control circuit 160, such as TFTs, is removed in each of the sub-pixels. The control unit 30, which comprises the inorganic TFTs that correspond to each of the sub-pixels, includes a first connector 34 for connecting the control unit 30 to the flexible display unit 40. The first connector 34 is electrically connected to sub-pixel electrodes 33 extending from the drains of the inorganic TFTs in the control unit 30, and a common electrode 31 extending from the source of the inorganic TFTs in the control unit 30. Also, the flexible display unit 40 includes a second connector 41 that is able to be connected to the first connector 34 of the control unit 30. The second connector 41 is electrically connected to the sub-pixel electrodes 120 and the common electrode 125 of the flexible display unit 40. Thus, if the first connector 34 and the second connector 41 are combined, it is possible to control ON/OFF of each of the sub-pixels in the flexible display unit 40 through the control unit 30.

A magnetic field controlled active reflector according to the exemplary embodiments of the present invention can control reflection or transmission of incident light according to application of a magnetic field. If the magnetic field controlled active reflector is applied to a dual-sided display panel, outdoor visibility can be increased.

Also, in the case of a magnetic display panel according to the exemplary embodiments of the present invention, a color filter, a front polarizer, and a rear polarizer, which are indispensable elements in a conventional liquid crystal display panel, are unnecessary. Accordingly, the transmission or the blocking of light can be controlled using a much small number of parts as compared to the conventional liquid crystal display panel, and thus, the magnetic display panel according to the present invention can be simpler and more inexpensively manufactured. Also, since the magnetic field controlled active reflector is used, external light can be further effectively utilized.

Also, when a magnetic display panel according to the present invention is manufactured, most of the conventional processes for manufacturing the liquid crystal display panel can be used.

Furthermore, the magnetic display panel according to the present invention does not require a high temperature manufacturing process, and thus, can be applied to form a flexible display panel.

The magnetic display panel according to the present invention can be easily manufactured to form a small screen and a large screen. Thus, the magnetic display panel can be widely applied to various sizes of electronic apparatuses that provide images such as TVs, PCs, notebooks, mobile phones, PMPs, or game instruments.

While this invention has been particularly shown and described with reference to exemplary embodiments thereof, it will be understood by one skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention, however by the appended claims, and all differences within the scope will be construed as being included in the present invention.

What is claimed is:

1. A reflector comprising:
a magnetic material layer fcomprising:
a transparent insulating medium;
magnetic particles disposed in the transparent insulating medium;
an optical surface including a plurality of curved surfaces which comprise first surfaces including convex parabolic shapes and axes of symmetry in centers of the first surfaces, and peripheral surfaces including focal points at the axes of symmetry of the first surfaces and concave parabolic shapes extending from the first surfaces, wherein the magnetic material layer reflects light or transmits light depending on whether a magnetic field is applied.

2. The reflector of claim 1, wherein when a magnetic field is applied to the magnetic material layer, the magnetic material layer transmits light having a first polarizing direction and reflects light having a second polarizing direction which is perpendicular to the first polarizing direction, and when the magnetic field is not applied to the magnetic material layer, the magnetic material layer reflects light having the first polarizing direction and light having the second polarizing direction.

3. The reflector of claim 1, wherein the magnetic material layer comprises magnetic particles including core-shell structures, color absorption particles including core-shell structures, and a medium, and the magnetic particles and the color absorption particles are mixed and distributed in the medium.

4. The reflector of claim 3, wherein each of the magnetic particles comprises a magnetic core formed of a magnetic material and an insulating shell that surrounds the magnetic core.

5. The reflector of claim 4, wherein the magnetic core includes a single magnetic domain.

6. The reflector of claim 4, wherein the magnetic core is formed of a magnetic material selected from the group consisting of Co, Fe, Iron oxide, Ni, Co—Pt alloy, Fe—Pt alloy, Ti, Al, Ba, Pt, Na, Sr, Mg, dysprosium (Dy), Mn, gadolinium (Gd), Ag, Cu, and Cr, or an alloy comprising at least two materials of the group.

7. The reflector of claim 3, wherein each of the color absorption particles comprises a core formed of a dielectric and a shell formed of a metal.

8. The reflector of claim 1, further comprising a magnetic field applying element which applies a magnetic field to the magnetic material layer, wherein the magnetic field applying element comprises a plurality of wires disposed parallel to each other and around the magnetic material layer and a power source that supplies a current to the plurality of wires.

9. The reflector of claim 8, wherein the plurality of wires are formed of one material selected from the group consisting of indium tin oxide (ITO), Al, Cu, Ag, Pt, Au, and iodine-doped polyacetylene.

10. A display pixel comprising:
a magnetic material layer that transmits light or does not transmit light depending on whether a magnetic field is applied, the magnetic material layer comprising one of a dye and color absorption particles;
a reflector disposed at a first surface of the magnetic material layer to reflect light that passes through the magnetic material layer;
a first electrode disposed at a first surface of the reflector;
a second electrode disposed at a second surface of the magnetic material layer; and
a conductor disposed at a third surface of the magnetic material layer, electrically connecting the first electrode to the second electrode.

11. The display pixel of claim 10, wherein the magnetic material layer transmits light of a first polarizing direction and reflects light of a second polarizing direction which is perpendicular direction to the first polarizing direction when the magnetic field is applied, and reflects all light when the magnetic field is not applied to the magnetic material layer.

12. The display pixel of claim 10, wherein the magnetic material layer comprises color absorption particles and further comprises magnetic particles, and the color absorption particles and the magnetic particles are mixed and distributed in a medium without agglomeration.

13. The display pixel of claim 12, wherein each of the magnetic particles comprises a magnetic core formed of a magnetic material and an insulating shell that surrounds the magnetic core.

14. The display pixel of claim 13, wherein the magnetic core is formed of a magnetic material selected from the group consisting of Co, Fe, Iron oxide, Ni, Co—Pt alloy, Fe—Pt alloy, Ti, Al, Ba, Pt, Na, Sr, Mg, dysprosium (Dy), Mn, gadolinium (Gd), Ag, Cu, and Cr, or an alloy comprising at least two materials of the group.

15. The display pixel of claim 12, wherein each of the color absorption particles comprises a core formed of a dielectric and a shell formed of a metal.

16. The display pixel of claim 10, further comprising a transparent front substrate on which the first electrode is disposed and a rear substrate on which the second electrode is disposed.

17. The display pixel of claim 16, further comprising an anti-reflection coating formed at at least one of surfaces between the magnetic material layer and a surface of the front substrate, and the surface of the front substrate.

18. The display pixel of claim 16, further comprising an absorptive polarizer formed at at least one of surfaces between the magnetic material layer and a surface of the front substrate, and the surface of the front substrate.

19. The display pixel of claim 10, wherein the reflector has a reflection surface including a plurality of curved surfaces which comprise first surfaces including convex parabolic shapes and axes of symmetry in centers of the first surfaces and peripheral surfaces including focal points on the axes of symmetry of the first surfaces and concave parabolic shapes extending from the first surfaces.

20. The display pixel of claim 10, wherein the second electrode comprises wires of a mesh structure or a lattice structure electrically connected to the conductive spacer.

21. The display pixel of claim 10, further comprising a control circuit that is disposed at a fourth surface of the magnetic material layer to switch a current flow between the first electrode and the second electrode.

22. A display panel comprising a plurality of display pixels of claim 10.

23. The display panel of claim 22, further comprising a transparent front substrate on which the first electrode is disposed and a rear substrate on which the second electrode is disposed.

24. The display panel of claim 23, wherein the display panel is a flexible display panel in which the front substrate, the rear substrate, the first electrode, and the second electrode are formed of flexible materials.

25. The display panel of claim 24, wherein the display panel comprises a flexible display unit on which a plurality of display pixels are disposed and a control unit that individually controls a current flow between the first electrode and the second electrode with respect to each of sub-pixels.
